(19) United States
(12) Patent Application Publication
(10) Pub. No.: US 2019/0019509 A1
(43) Pub. Date: Jan. 17, 2019

(54) VOICE DATA PROCESSING METHOD AND ELECTRONIC DEVICE FOR SUPPORTING THE SAME

(71) Applicant: Samsung Electronics Co., Ltd., Gyeonggi-do (KR)

(72) Inventors: Da Som LEE, Seoul (KR); Jae Yung YEO, Gyeonggi-do (KR); Yong Joon JEON, Gyeonggi-do (KR)

(21) Appl. No.: 16/035,975

(22) Filed: Jul. 16, 2018

(30) Foreign Application Priority Data
Jul. 17, 2017 (KR) 10-2017-0090301

(51) Int. Cl. G10L 15/22; G10L 15/30; G10L 15/18

(52) U.S. Cl. CPC G10L 15/22; G10L 2015/223; G10L 15/1815; G10L 15/30

(57) ABSTRACT

An electronic device and method are disclosed. The device includes a communication circuit, at least one processor, and at least one memory. The memory stores instructions executable by the processor to implement the method, including obtaining voice data from an external device via the communication circuit, converting the voice data into text data, detect at least one expression included in the text data, when the at least one expression includes a first expression mapped to a first task, transmitting first information indicating a sequence of states associated with performing the first task to the external device via the communication circuit, and when the at least one expression does not include the first expression and includes a second expression different from the first expression, and the second expression is mapped to the first expression as stored in a database (DB), transmitting the first information to the external device via the communication circuit.

### CROSS-REFERENCE TO RELATED APPLICATION(S)

This application is based on and claims priority under 35 U.S.C. § 119 to Korean Patent Application No. 10-2017-0090301, filed on Jul. 17, 2017, in the Korean Intellectual Property Office, the disclosure of which is incorporated by reference herein its entirety.

### TECHNICAL FIELD

The present disclosure relates to technologies for voice data processing, and more particularly, to voice data processing in an artificial intelligence (AI) system which uses a machine learning algorithm and an application thereof.

### BACKGROUND

An AI system (or integrated intelligent system) refers to a system that trains and judges by itself and improves a recognition rate as it is used, as a computer system in which human intelligence is implemented.

AI technology may include machine learning (deep learning) technologies using an algorithm that classifies or trains characteristics of input data by themselves and element technologies that simulate functions of the human brain, for example, recognition, decision, and the like, using a machine learning algorithm.

For example, the element technologies may include at least one of, for example, a language understanding technology for recognizing languages or characters of humans, a visual understanding technology for recognizing objects like human vision, an inference/prediction technology for determines information to logically infer and predict the determined information, a knowledge expression technology for processing human experience information as knowledge data, and an operation control technology for controlling autonomous driving of vehicles and the motion of robots.

The language understanding technology among the above-mentioned element technologies includes technologies of recognizing and applying/processing human languages/characters and may include natural language processing, machine translation, dialogue system, question and answer, speech recognition/synthesis, and the like.

Meanwhile, if a specified hardware key is pressed or if a specified voice is input through a microphone, an electronic device equipped with an AI system may execute an intelligence app (or application) such as a speech recognition app and may enter an idle state for receiving a voice input of a user through the intelligence app. For example, the electronic device may display a user interface (UI) of the intelligence app on a screen of its display. If a voice input button on the UI is touched, the electronic device may receive a voice input of the user.

Further, the electronic device may transmit voice data corresponding to the received voice input to an intelligence server. In this case, the intelligence server may convert the received voice data into text data and may determine information about a sequence of states of the electronic device associated with a task to be performed by the electronic device, for example, a path rule, based on the converted text data. Thereafter, the electronic device may receive the path rule from the intelligence server and may perform the tasks depending on the path rule.

The above information is presented as background information only to assist with an understanding of the present disclosure. No determination has been made, and no assertion is made, as to whether any of the above might be applicable as prior art with regard to the present disclosure.

### SUMMARY

However, when an expression for explicitly requesting to perform a task is not included in text data, a conventional electronic device may fail to determine a path rule. For example, if an identifier of an application executable by an external device to perform the task, a command set to execute a function of the application, and the like are not included in the text data, the electronic device may fail to determine information about a sequence of states of the external device associated with performing the task. Thus, the external device may fail to perform the task.

Aspects of the present disclosure are to address at least the above-mentioned problems and/or disadvantages and to provide at least the advantages described below. Accordingly, an aspect of the present disclosure is to provide a voice data processing method for, although an expression (e.g., an explicit expression or a direct expression) for explicitly requesting to perform a task is not included in text data obtained by converting voice data obtained in response to an utterance input of a user into a text format, when there is another expression (e.g., an inexplicit expression or an indirect expression) mapped to the expression, performing the task and a system for supporting the same.

In accordance with an aspect of the present disclosure, an electronic device is disclosed including a network interface, at least one processor configured to be operatively connected with the network interface, and at least one memory configured to be operatively connected with the at least one processor. The at least one memory stores instructions, which when executed, cause the at least one processor to in a first operation: receive by the network interface first data associated with a first user input from a first external device including a microphone, the first user input including an explicit request for performing a task using at least one of the first external device or a second external device, identify a function requested by the first user input using natural understanding processing, determine a sequence of states executable by the first external device or the second external device for executing the requested function, transmit first information indicating the determined sequence of the states to at least one of the first external device and the second external device using the network interface, in second operation: receive by the network interface second data associated with a second user input from the first external device, the second user input including a natural language expression, identifying the function from the natural language expression, based at least in part on mappings of functions with natural language expressions previously received by the electronic device, determine the sequence of the states executable by the first external device or the second external device for executing the identified function, and transmit second information indicating the sequence of the states to at least one of the first external device and the second external device using the network interface.

In accordance with another aspect of the present disclosure, an electronic device includes a communication circuit, at least one processor configured to be operatively connected with the communication circuit, and at least one memory configured to be operatively connected with the at least one processor. The at least one memory stores instructions, which when executed, cause the at least one processor to obtain voice data from an external device via the communication circuit, convert the voice data into text data, detect at least one expression included in the text data, when the at least one expression includes a first expression mapped to a first task, transmit first information indicating a sequence of states associated with performing the first task to the external device via the communication circuit, and when the at least one expression does not include the first expression and includes a second expression different from the first expression, and the second expression is mapped to the first expression as stored in a database (DB), transmit the first information to the external device via the communication circuit.

In accordance with another aspect of the present disclosure, a voice data processing method of an electronic device includes obtaining voice data from an external device via a communication circuit of the electronic device, converting by a processor the voice data into text data, when the at least one expression includes a first expression, transmitting first information indicating a sequence of states associated with performing the first task to the external device via the communication circuit, when the at least one expression does not include the first expression and includes a second expression different from the first expression and the second expression is mapped to the first expression as stored in a database (DB), transmitting the first information to the external device via the communication circuit.

According to embodiments disclosed in the present disclosure, although a user does not speak an expression for explicitly requesting to perform a task, that is, although he or she provides an inexplicit utterance (e.g., an indirect utterance) rather than an explicit utterance (or a direct utterance), an electronic device may perform the task, thus increasing in availability and convenience.

In addition, various effects directly or indirectly ascertained through the present disclosure may be provided.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a drawing illustrating an integrated intelligent system according to various embodiments of the present disclosure.

FIG. 2 is a block diagram illustrating a user terminal of an integrated intelligence system according to an embodiment of the present disclosure.

FIG. 3 is a drawing illustrating a method for executing an intelligence app of a user terminal according to an embodiment of the prevent disclosure.

FIG. 4 is a drawing illustrating a method for collecting a current state at a context module of an intelligence service module according to an embodiment of the present disclosure.

FIG. 5 is a block diagram illustrating a proposal module of an intelligence service module according to an embodiment of the present disclosure.

FIG. 6 is a block diagram illustrating an intelligence server of an integrated intelligent system according to an embodiment of the present disclosure.

FIG. 7 is a drawing illustrating a method for generating a path rule at a path planner module according to an embodiment of the present disclosure.

FIG. 8 is a block diagram illustrating a method for managing user information at a persona module of an intelligence service module according to an embodiment of the present disclosure.

FIG. 9 is a flowchart illustrating an operation method of a system associated with processing voice data according to an embodiment of the present disclosure.

FIG. 10 is a flowchart illustrating an operation method of a system associated with training an inexplicit utterance according to an embodiment of the present disclosure.

FIG. 11 is a flowchart illustrating an operation method of a system associated with processing an inexplicit expression mapped with a plurality of explicit expressions according to an embodiment of the present disclosure.

FIG. 12 is a flowchart illustrating an operation method of a system associated with processing a plurality of inexplicit expression according to an embodiment of the present disclosure.

FIG. 13 is a flowchart illustrating another operation method of a system associated with processing a plurality of inexplicit expression according to an embodiment of the present disclosure.

FIG. 14 is a drawing illustrating a screen associated with processing voice data according to an embodiment of the present disclosure.

FIG. 15 is a drawing illustrating a case in which a task is not performed upon an inexplicit utterance, according to an embodiment of the present disclosure.

FIG. 16 is a drawing illustrating a case in which a task is performed upon an inexplicit utterance, according to an embodiment of the present disclosure.

FIG. 17 is a drawing illustrating a method for processing an inexplicit expression mapped with a plurality of explicit expressions according to an embodiment of the present disclosure.

FIG. 18 is a drawing illustrating a screen associated with training an inexplicit utterance according to an embodiment of the present disclosure.

FIG. 19 illustrates a block diagram of an electronic device in a network environment, according to various embodiments.

Throughout the drawings, it should be noted that like reference numbers are used to depict the same or similar elements, features, and structures.

### DETAILED DESCRIPTION

Hereinafter, various embodiments of the present disclosure may be described to be associated with accompanying drawings. Accordingly, those of ordinary skill in the art will recognize that modification, equivalent, and/or alternative on the various embodiments described herein can be variously made without departing from the present disclosure.

Before describing an embodiment of the present disclosure, a description will be given of an integrated intelligent system to which an embodiment of the present disclosure is applied.

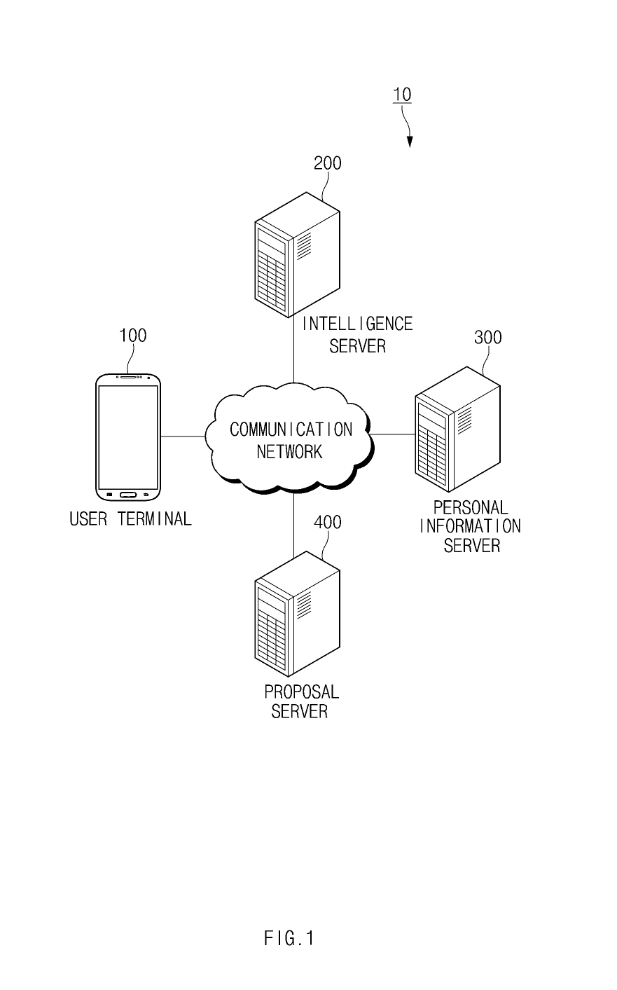

FIG. 1 is a drawing illustrating an integrated intelligent system according to various embodiments of the present disclosure.

Referring to FIG. 1, an integrated intelligent system 10 may include a user terminal 100, an intelligence server 200, a personal information server 300, or a proposal server 400.

The user terminal 100 may provide a service for a user through an app (or an application program) (e.g., an alarm app, a message app, a photo (gallery) app, or the like) stored in the user terminal 100. For example, the user terminal 100 may execute and operate another app through an intelligence app (or a speech recognition app) stored in the user terminal 100. The user terminal 100 may receive a user input for executing the other app and executing an action through the intelligence app. The user input may be received through, for example, a physical button, a touch pad, a voice input, a remote input, or the like. According to an embodiment, the user terminal 100 may correspond to each of various terminals devices (or various electronic devices) connectable to the Internet, for example, a mobile phone, a smartphone, a personal digital assistant (PDA), or a notebook computer.

According to an embodiment, the user terminal 100 may receive an utterance of the user as a user input. The user terminal 100 may receive the utterance of the user and may generate a command to operate an app based on the utterance of the user. Thus, the user terminal 100 may operate the app using the command.

The intelligence server 200 may receive a voice input (or voice data) of the user over a communication network from the user terminal 100 and may change (or convert) the voice input to text data. In another example, the intelligence server 1200 may generate (or select) a path rule based on the text data. The path rule may include information about a sequence of states of a specific electronic device (e.g., the user terminal 100) associated with a task to be performed by the electronic device. For example, the path rule may include information about an action (or an operation) for performing a function of an app installed in the electronic device or information about a parameter utilizable to execute the action. Further, the path rule may include an order of the action. The user terminal 100 may receive the path rule and may select an app depending on the path rule, thus executing an action included in the path rule in the selected app.

In general, the term “path rule” in the present disclosure may refer to, but is not limited to, a sequence of states for the electronic device to perform a task requested by the user. In other words, the path rule may include information about the sequence of the states. The task may be, for example, any action capable of being applied by an intelligence app. The task may include generating a schedule, transmitting a photo to a desired target, or providing weather information. The user terminal 100 may perform the task by sequentially having at least one or more states (e.g., an action state of the user terminal 100).

According to an embodiment, the path rule may be provided or generated by an artificial intelligence (AI) system. The AI system may be a rule-based system or may a neural network-based system (e.g., a feedforward neural network (FNN) or a recurrent neural network (RNN)). Alternatively, the AI system may be a combination of the above-mentioned systems or an AI system different from the above-mentioned systems. According to an embodiment, the path rule may be selected from a set of pre-defined path rules or may be generated in real time in response to a user request. For example, the AI system may select at least one of a plurality of pre-defined path rules or may generate a path rule on a dynamic basis (or on a real-time basis). Further, the user terminal 100 may use a hybrid system for providing a path rule.

According to an embodiment, the user terminal 100 may execute the action and may display a screen corresponding to a state of the user terminal 100 which executes the action on its display. For another example, the user terminal 100 may execute the action and may fail to display the result of performing the action on the display. For another example, the user terminal 100 may execute a plurality of actions and may display the result of performing some of the plurality of actions on the display. For example, the user terminal 100 may display the result of executing an action of the final order on the display. For another example, the user terminal 100 may receive an input of the user and may display the result of executing the action on the display.

The personal information server 300 may include a database (DB) in which user information is stored. For example, the personal information server 300 may receive user information (e.g., context information, app execution information, or the like) from the user terminal 100 and may store the received user information in the DB. The intelligence server 200 may receive the user information over the communication network from the personal information server 300 and may use the user information when generating a path rule for a user input. According to an embodiment, the user terminal 100 may receive user information over the communication network from the personal information server 300 and may use the user information as information for managing the DB.

The proposal server 400 may include a DB which stores information about a function in the user terminal 100 or a function to be introduced or provided in an application. For example, the proposal server 400 may receive user information of the user terminal 100 from the personal information server 300 and may implement a DB for a function capable of being used by the user using the user information. The user terminal 100 may receive the information about the function to be provided, over the communication network from the proposal server 400 and may provide the received information to the user.

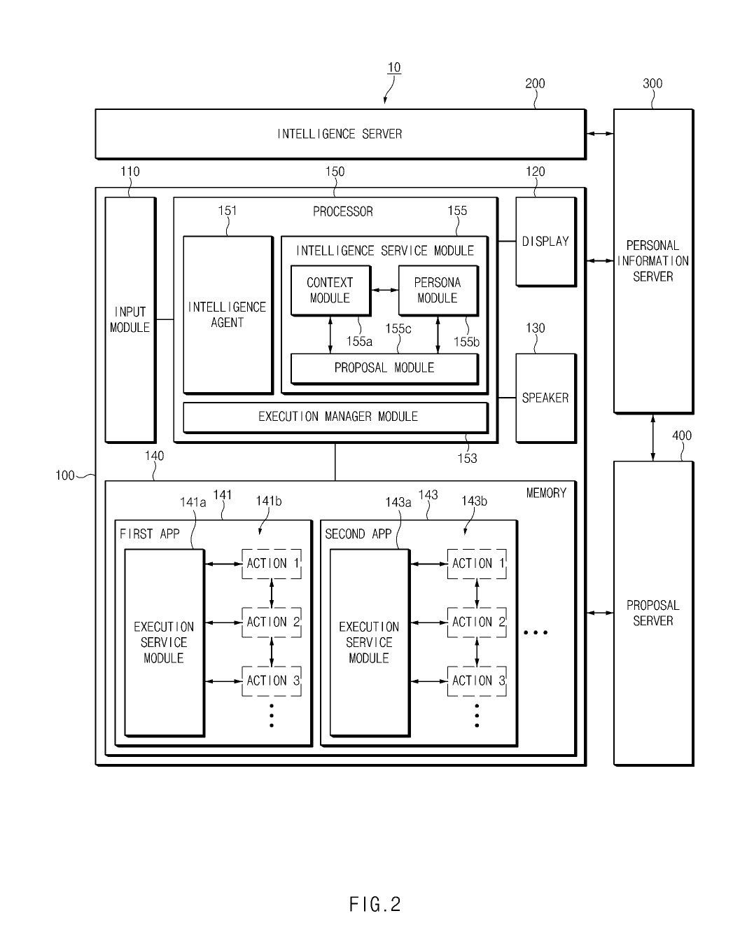

FIG. 2 is a block diagram illustrating a user terminal of an integrated intelligence system according to an embodiment of the present disclosure.

Referring to FIG. 2, a user terminal 100 may include an input module 110, a display 120, a speaker 130, a memory 140, or a processor 150. The user terminal 100 may further include a housing. The elements of the user terminal 100 may be received in the housing or may be located on the housing.

The input module 110 according to an embodiment may receive a user input from a user. For example, the input module 110 may receive a user input from an external device (e.g., a keyboard or a headset) connected to the input module 110. For another example, the input module 110 may include a touch screen (e.g., a touch screen display) combined with the display 120. For another example, the input module 110 may include a hardware key (or a physical key) located in the user terminal 100 (or the housing of the user terminal 100).

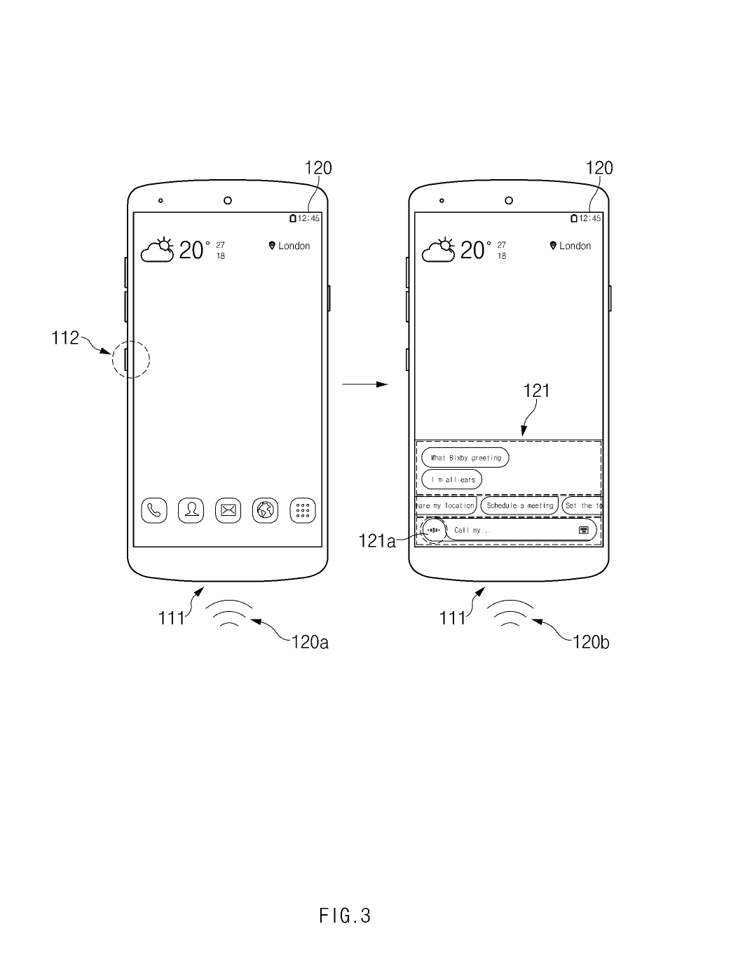

According to an embodiment, the input module 110 may include a microphone (e.g., a microphone 111 of FIG. 3) capable of receiving an utterance of the user as a voice signal (or voice data). For example, the input module 110 may include a speech input system and may receive an utterance of the user as a voice signal via the speech input system.

The display 120 according to an embodiment may display an image or video and/or a screen where an application is executed. For example, the display 120 may display a graphic user interface (GUI) of an app.

According to an embodiment, the speaker 130 may output a voice signal. For example, the speaker 130 may output a voice signal generated in the user terminal 100 to the outside.

According to an embodiment, the memory 140 may store a plurality of apps (or application programs) 141 and 143. The plurality of apps 141 and 143 stored in the memory 140 may be selected, executed, and operated according to a user input.

According to an embodiment, the memory 140 may include a DB capable of storing information utilizable to recognize a user input. For example, the memory 140 may include a log DB capable of storing log information. For another example, the memory 140 may include a persona DB capable of storing user information.

According to an embodiment, the memory 140 may store the plurality of apps 141 and 143. The plurality of apps 141 and 143 may be loaded to operate. For example, the plurality of apps 141 and 143 stored in the memory 140 may be loaded by an execution manager module 153 of the processor 150 to operate. The plurality of apps 141 and 143 may respectively include execution service modules 141a and 143a for performing a function. In an embodiment, the plurality of apps 141 and 143 may execute a plurality of actions 1141b and 1143b (e.g., a sequence of states), respectively, through the execution service modules 141a and 143a to perform a function. In other words, the execution service modules 141a and 143a may be activated by the execution manager module 153 and may execute the plurality of actions 141b and 143b, respectively.

According to an embodiment, when the actions 141b and 143b of the apps 141 and 143 are executed, an execution state screen (or an execution screen) according to the execution of the actions 141b and 143b may be displayed on the display 120. The execution state screen may be, for example, a screen of a state where the actions 141b and 143b are completed. For another example, the execution state screen may be, for example, a screen of a state (partial landing) where the execution of the actions 141b and 143b is stopped (e.g., when a parameter utilizable for the actions 141b and 143b is not input).

The execution service modules 141a and 143a according to an embodiment may execute the actions 141b and 143b, respectively, depending on a path rule. For example, the execution service modules 141a and 143a may be activated by the execution manager module 153 and may execute a function of each of the apps 141 and 143 by receiving an execution request according to the path rule from the execution manager module 153 and performing the actions 141b and 143b depending on the execution request. When the performance of the actions 141b and 143b is completed, the execution service modules 141a and 143a may transmit completion information to the execution manager module 153.

According to an embodiment, when the plurality of actions 141b and 143b are respectively executed in the apps 141 and 143, the plurality of actions 141b and 143b may be sequentially executed. When execution of one action (e.g., action 1 of the first app 141 or action 1 of the second app 143) is completed, the execution service modules 141a and 143a may open a next action (e.g., action 2 of the first app 141 or action 2 of the second app 143) and may transmit completion information to the execution manager module 153. Herein, opening any action may be understood as changing the any operation to an executable state or preparing for executing the any action. In other words, when the any operation is not opened, it may fail to be executed. When the completion information is received, the execution manager module 153 may transmit a request to execute the next action (e.g., action 2 of the first app 141 or action 2 of the second app 143) to the execution service modules 141b and 143b. According to an embodiment, when the plurality of apps 141 and 143 are executed, they may be sequentially executed. When receiving completion information from the first execution service module 141a after execution of a final action (e.g., action 3) of the first app 141 is completed, the execution manager module 153 may transmit a request to execute a first action (e.g., action 1) of the second app 143 to the second execution service module 143a.

According to an embodiment, when the plurality of actions 141b and 143b are respectively executed in the apps 141 and 143, a result screen according to the execution of each of the plurality of actions 141b and 143b may be displayed on the display 120. In some embodiments, some of a plurality of result screens according to the execution of the plurality of actions 141b and 143b may be displayed on the display 120.

According to an embodiment, the memory 140 may store an intelligence app (e.g., a speech recognition app) which interworks with an intelligence agent 151. The app which interworks with the intelligence agent 151 may receive and process an utterance of the user as a voice signal (or voice data). According to an embodiment, the app which interworks with the intelligence agent 151 may be operated by a specific input (e.g., an input through a hardware key, an input through a touch screen, or a specific voice input) input through the input module 110.

According to an embodiment, the processor 150 may control an overall operation of the user terminal 100. For example, the processor 150 may control the input module 110 to receive a user input. For another example, the processor 150 may control the display 120 to display an image. For another example, the processor 150 may control the speaker 130 to output a voice signal. For another example, the processor 150 may control the memory 140 to fetch or store utilizable information.

According to an embodiment, the processor 150 may include the intelligence agent 151, the execution manager module 153, or an intelligence service module 155. In an embodiment, the processor 150 may execute instructions stored in the memory 140 to drive the intelligence agent 151, the execution manager module 153, or the intelligence service module 155. The several modules described in various embodiments of the present disclosure may be implemented in hardware or software. In various embodiments of the present disclosure, an operation performed by the intelligence agent 151, the execution manager module 153, or the intelligence service module 155 may be understood as an operation performed by the processor 150.

The intelligence agent 151 according to an embodiment may generate a command to operate an app based on a voice signal (or voice data) received as a user input. The execution manager module 153 according to an embodiment may receive the generated command from the intelligence agent 151 and may select, execute, and operate the apps 141 and 143 stored in the memory 140 based on the generated command. According to an embodiment, the intelligence service module 155 may manage user information and may use the user information to process a user input.

The intelligence agent 151 may transmit a user input received through the input module 110 to an intelligence server 200.

According to an embodiment, the intelligence agent 151 may preprocess the user input before transmitting the user input to the intelligence server 200. According to an embodiment, to preprocess the user input, the intelligence agent 151 may include an adaptive echo canceller (AEC) module, a noise suppression (NS) module, an end-point detection (EPD) module, or an automatic gain control (AGC) module. The AEC module may cancel an echo included in the user input. The NS module may suppress background noise included in the user input. The EPD module may detect an end point of a user voice included in the user input and may find a portion (e.g., a voiced band) where there is a voice of the user. The AGC module may adjust volume of the user input to be suitable for recognizing and processing the user input. According to an embodiment, the intelligence agent 151 may include all the preprocessing elements for performance. However, in another embodiment, the intelligence agent 151 may include some of the preprocessing elements to operate with a low power.

According to an embodiment, the intelligence agent 151 may include a wake-up recognition module for recognizing calling of the user. The wake-up recognition module may recognize a wake-up command (e.g., a wake-up word) of the user through a speech recognition module. When receiving the wake-up command, the wake-up recognition module may activate the intelligence agent 151 to receive a user input. According to an embodiment, the wake-up recognition module of the intelligence agent 151 may be implemented in a low-power processor (e.g., a processor included in an audio codec). According to an embodiment, the intelligence agent 151 may be activated according to a user input through a hardware key. When the intelligence agent 151 is activated, an intelligence app (e.g., a speech recognition app) which interworks with the intelligence agent 151 may be executed.

According to an embodiment, the intelligence agent 151 may include a speech recognition module for executing a user input. The speech recognition module may recognize a user input for executing an action in an app. For example, the speech recognition module may recognize a limited user (voice) input for executing an action such as the wake-up command (e.g., utterance like “a click” for executing an image capture operation while a camera app is executed). The voice recognition module which helps the intelligence server 200 with recognizing a user input may recognize and quickly process, for example, a user command capable of being processed in the user terminal 100. According to an embodiment, the speech recognition module for executing the user input of the intelligence agent 151 may be implemented in an app processor.

According to an embodiment, the speech recognition module (including a speech recognition module of the wake-up recognition module) in the intelligence agent 151 may recognize a user input using an algorithm for recognizing a voice. The algorithm used to recognize the voice may be at least one of, for example, a hidden Markov model (HMM) algorithm, an artificial neural network (ANN) algorithm, or a dynamic time warping (DTW) algorithm.

According to an embodiment, the intelligence agent 151 may convert a voice input (or voice data) of the user into text data. According to an embodiment, the intelligence agent 151 may transmit a voice of the user to the intelligence server 200, and the intelligence server 200 may convert the voice of the user into text data. The intelligence agent 151 may receive the converted text data. Thus, the intelligence agent 151 may display the text data on the display 120.

According to an embodiment, the intelligence agent 151 may receive a path rule transmitted from the intelligence server 200. According to an embodiment, the intelligence agent 151 may transmit the path rule to the execution manager module 153.

According to an embodiment, the intelligence agent 151 may transmit an execution result log according to the path rule received from the intelligence server 200 to an intelligence service module 155. The transmitted execution result log may be accumulated and managed in preference information of the user of a persona module (or a persona manager) 155b.

The execution manager module 153 according to an embodiment may receive a path rule from the intelligence agent 151 and may execute the apps 141 and 143 depending on the path rule such that the apps 141 and 143 respectively execute the actions 141b and 143b included in the path rule. For example, the execution manager module 153 may transmit command information (e.g., path rule information) for executing the actions 141b and 143b to the apps 141 and 143 and may receive completion information of the actions 141b and 143b from the apps 141 and 143.

According to an embodiment, the execution manager module 153 may transmit and receive command information (e.g., path rule information) for executing the actions 141b and 143b of the apps 141 and 143 between the intelligence agent 151 and the apps 141 and 143. The execution manager module 153 may bind the apps 141 and 143 to be executed according to the path rule and may transmit command information (e.g., path rule information) of the actions 141b and 143b included in the path rule to the apps 141 and 143. For example, the execution manager module 153 may sequentially transmit the actions 141b and 143b included in the path rule to the apps 141 and 143 and may sequentially execute the actions 141b and 143b of the apps 141 and 143 depending on the path rule.

According to an embodiment, the execution manager module 153 may manage a state where the actions 141b and 143b of the apps 141 and 143 are executed. For example, the execution manager module 153 may receive information about a state where the actions 141b and 143b are executed from the apps 141 and 143. For example, when a state where the actions 141b and 143b are executed is a stopped state (partial landing) (e.g., when a parameter utilizable for the actions 141b and 143b is not input), the execution manager module 153 may transmit information about the state (partial landing) to the intelligence agent 151. The intelligence agent 151 may request to input information (e.g., parameter information) utilizable for the user, using the received information. For another example, when the state where the actions 141b and 143b are executed is an action state, the execution manager module 153 may receive utterance from the user and may transmit the executed apps 141 and 143 and information about a state where the apps 141 and 143 are executed to the intelligence agent 151. The intelligence agent 151 may receive parameter information of an utterance of the user through the intelligence server 200 and may transmit the received parameter information to the execution manager module 153. The execution manager module 153 may change a parameter of each of the actions 141b and 143b to a new parameter using the received parameter information.

According to an embodiment, the execution manager module 153 may transmit parameter information included in the path rule to the apps 141 and 143. When the plurality of apps 141 and 143 are sequentially executed according to the path rule, the execution manager module 153 may transmit the parameter information included in the path rule from one app to another app.

According to an embodiment, the execution manager module 153 may receive a plurality of path rules. The execution manager module 153 may receive the plurality of path rules based on an utterance of the user. For example, when an utterance of the user specifies the first app 141 to execute some actions (e.g., the action 1141b), but when it does not specify the other second app 143 to execute the other actions (e.g., the action 143b), the execution manager module 153 may receive a plurality of different path rules capable of executing the first app 141 (e.g., a gallery app) and the plurality of different apps 143 (e.g., a message app and a telegram app). In other words, the execution manager module 153 may receive a first path rule in which the first app 141 (e.g., the gallery app) to execute the some actions (e.g., the action 141b) is executed and in which any one (e.g., the message app) of the second apps 143 capable of executing the other actions (e.g., the action 143b) is executed and a second path rule in which the first app 141 (e.g., the gallery app) to execute the some actions (e.g., the action 141b) is executed and in which the other (e.g., the telegram app) of the second apps 143 capable of executing the other actions (e.g., the action 143b) is executed.

According to an embodiment, the execution manager module 153 may execute the same actions 141b and 143b (e.g., the consecutive same actions 141b and 143b) included in the plurality of path rules. When the same actions are executed, the execution manager module 153 may display a state screen capable of selecting the different apps 141 and 143 included in the plurality of path rules on the display 120.

According to an embodiment, the intelligence service module 155 may include a context module 155a, a persona module 155b, or a proposal module 155c.

The context module 155a may collect a current state of each of the apps 141 and 143 from the apps 141 and 143. For example, the context module 155a may receive context information indicating the current state of each of the apps 141 and 143 and may collect the current state of each of the apps 141 and 143.

The persona module 155b may manage personal information of the user who uses the user terminal 100. For example, the persona module 155b may collect information (or usage history information) about the use of the user terminal 100 and the result of performing the user terminal 100 and may manage the personal information of the user.

The proposal module 155c may predict an intent of the user and may recommend a command to the user. For example, the proposal module 155c may recommend the command to the user in consideration of a current state (e.g., time, a place, a situation, or an app) of the user.

FIG. 3 is a drawing illustrating a method for executing an intelligence app of a user terminal according to an embodiment of the prevent disclosure.

Referring to FIG. 3, a user terminal 100 of FIG. 2 may receive a user input and may execute an intelligence app (e.g., a speech recognition app) which interworks with an intelligence agent 151 of FIG. 2.

According to an embodiment, the user terminal 100 may execute an intelligence app for recognizing a voice through a hardware key 112. For example, when receiving a user input through the hardware key 112, the user terminal 100 may display a user interface (UI) 121 of the intelligence app on a display 120. In this case, a user may touch a speech recognition button 121a included in the UI 121 of the intelligence app to input (120b) a voice in a state where the UI 121 of the intelligence app is displayed on the display 120. For another example, the user may input (120b) a voice by keeping the hardware key 112 pushed.

According to an embodiment, the user terminal 100 may execute an intelligence app for recognizing a voice through a microphone 111. For example, when a specified voice (or a wake-up command) (e.g., “wake up!”) is input (120a) through the microphone 111, the user terminal 100 may display the UI 121 of the intelligence app on the display 120.

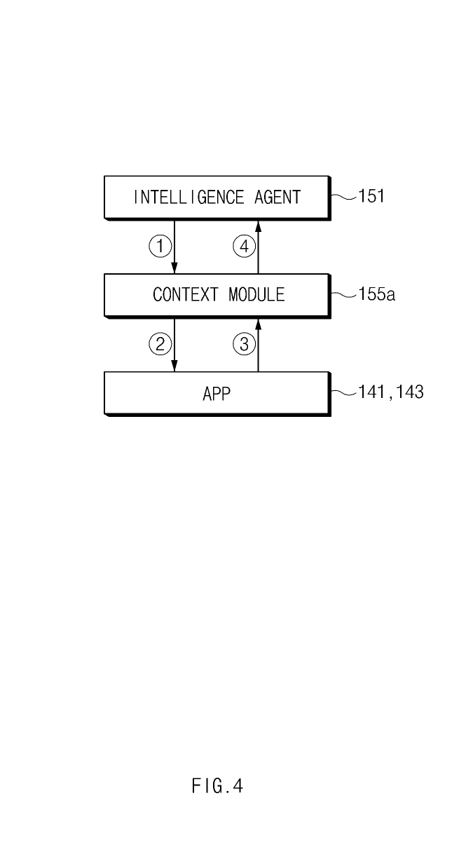

FIG. 4 is a drawing illustrating a method for collecting a current state at a context module of an intelligence service module according to an embodiment of the present disclosure.

Referring to FIG. 4, when receiving (\textcircled{1}) a context request from an intelligence agent 151, a context module 155a may request (\textcircled{2}) the apps 141 and 143 to provide context information indicating a current state of each of the apps 141 and 143. According to an embodiment, the context module 155a may receive (\textcircled{3}) the context information from each of the apps 141 and 143 and may transmit (\textcircled{4}) the received context information to the intelligence agent 151.

According to an embodiment, the context module 155a may receive a plurality of context information through the apps 141 and 143. For example, the context information may be information about the latest executed apps 141 and 143. For another example, the context information may be information about a current state in the apps 141 and 143 (e.g., information about a photo when a user views the photo in a gallery).

According to an embodiment, the context module 155a may receive context information indicating a current state of a user terminal 100 of FIG. 2 from a device platform as well as the apps 141 and 143. The context information may include general context information, user context information, or device context information.

The general context information may include general information of the user terminal 100. The general context information may be verified through an internal algorithm by data received via a sensor hub or the like of the device platform. For example, the general context information may include information about a current space-time. The information about the current space-time may include, for example, a current time or information about a current location of the user terminal 100. The current time may be verified through a time on the user terminal 100. The information about the current location may be verified through a global positioning system (GPS). For another example, the general context information may include information about physical motion. The information about the physical motion may include, for example, information about walking, running, or driving. The information about the physical motion may be verified through a motion sensor. The information about the driving may be used to verify a vehicle drive through the motion sensor and verify that a user rides in a vehicle and parks the vehicle by detecting a Bluetooth connection in the vehicle. For another example, the general context information may include user activity information. The user activity information may include information about, for example, commute, shopping, a trip, or the like. The user activity information may be verified using information about a place registered in a DB by a user or an app.

The user context information may include information about the user. For example, the user context information may include information about an emotional state of the user. The information about the emotional state may include information about, for example, happiness, sadness, anger, or the like of the user. For another example, the user context information may include information about a current state of the user. The information about the current state may include information about, for example, interest, intent, or the like (e.g., shopping).

The device context information may include information about a state of the user terminal 100. For example, the device context information may include information about a path rule executed by an execution manager module 153 of FIG. 2. For another example, the device context information may include information about a battery. The information about the battery may be verified through, for example, a charging and discharging state of the battery. For another example, the device context information may include information about a connected device and network. The information about the connected device may be verified through, for example, a communication interface to which the device is connected.

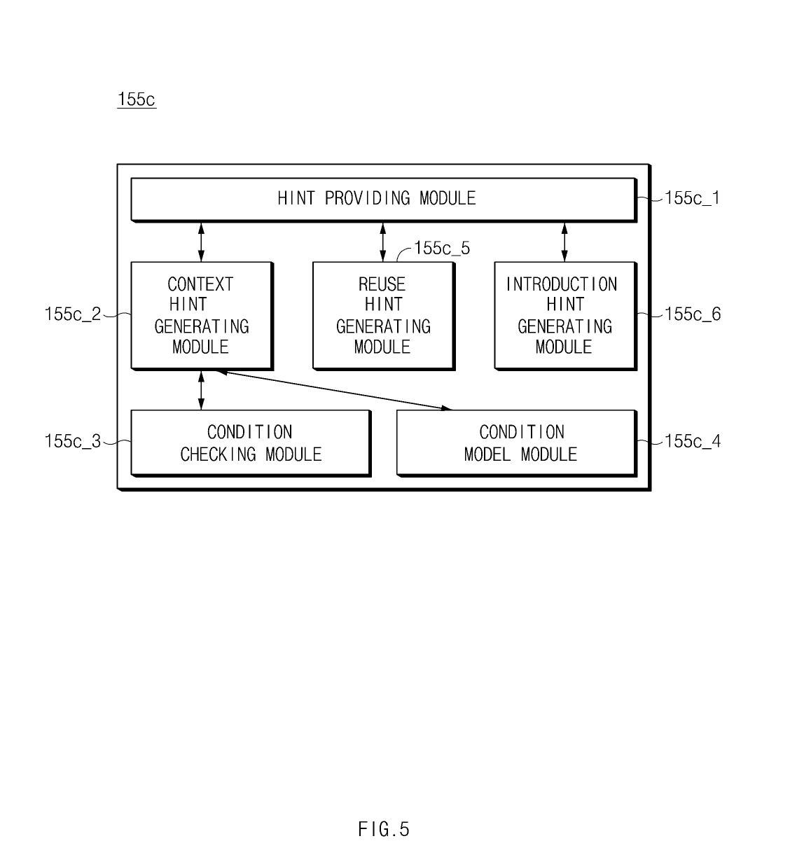

FIG. 5 is a block diagram illustrating a proposal module of an intelligence service module according to an embodiment of the present disclosure.

Referring to FIG. 5, a proposal module 155c may include a hint providing module 155c_1, a context hint generating module 155c_2, a condition checking module 155c_3, a condition model module 155c_4, and a reuse hint generating module 155c_5, or an introduction hint generating module 155c_6.

According to an embodiment, the hint providing module 155c_1 may provide a hint to a user. For example, the hint providing module 155c_1 may receive a hint generated from the context hint generating module 155c 2, the reuse hint generating module 155c_5, or the introduction hint generating module 155c_6 and may provide the hint to the user.

According to an embodiment, the context hint generating module 155c_2 may generate a hint capable of being recommended according to a current state through the condition checking module 155c_3 or the condition model module 155c_4. The condition checking module 155c_3 may receive information corresponding to a current state through an intelligence service module 155 of FIG. 2. The condition model module 155c 4 may set a condition model using the received information. For example, the condition model module 155c_4 may determine a time when a hint is provided to the user, a location where the hint is provided to the user, a situation where the hint is provided to the user, an app which is in use when the hint is provided to the user, and the like and may provide a hint with a high possibility of being used in a corresponding condition to the user in order of priority.

According to an embodiment, the reuse hint generating module 155c_5 may generate a hint capable of being recommended in consideration of a frequency of use depending on a current state. For example, the reuse hint generating module 155c_5 may generate the hint in consideration of a usage pattern of the user.

According to an embodiment, the introduction hint generating module 155c_6 may generate a hint of introducing a new function or a function frequently used by another user to the user. For example, the hint of introducing the new function may include introduction (e.g., an operation method) of an intelligence agent 151 of FIG. 2.

According to another embodiment, the context hint generating module 155c_2, the condition checking module 155c_3, the condition model module 155c_4, the reuse hint generating module 155c_5, or the introduction hint generating module 155c_6 of the proposal module 155c may be included in a personal information server 300 of FIG. 2. For example, the hint providing module 155c_1 of the proposal module 155c may receive a hint from the context hint generating module 155c 2, the reuse hint generating module 155c_5, or the introduction hint generating module 155c_6 of the personal information server 300 and may provide the received hint to the user.

According to an embodiment, a user terminal 100 of FIG. 2 may provide a hint depending on the following series of processes. For example, when receiving (\textcircled{1}) a hint providing request from the intelligence agent 151, the hint providing module 155c_1 may transmit (\textcircled{2}) the hint generation request to the context hint generating module 155c_2. When receiving the hint generation request, the context hint generating module 155c_2 may receive (\textcircled{4}) information corresponding to a current state from a context module 155a and a persona module 155b of FIG. 2 using (\textcircled{3}) the condition checking module 155c_3. The condition checking module 155c_3 may transmit (\textcircled{5}) the received information to the condition model module 155c_4. The condition model module 155c 4 may assign a priority to a hint with a high possibility of being used in the condition among hints provided to the user using the information. The context hint generating module 155c 2 may verify (\textcircled{6}) the condition and may generate a hint corresponding to the current state. The context hint generating module 155c_2 may transmit (\textcircled{7}) the generated hint to the hint providing module 155c_1. The hint providing module 155c_1 may arrange the hint depending on a specified rule and may transmit (\textcircled{8}) the hint to the intelligence agent 151.

According to an embodiment, the hint providing module 155c_1 may generate a plurality of context hints and may prioritize the plurality of context hints depending on a specified rule. According to an embodiment, the hint providing module 155c_1 may first provide a hint with a higher priority among the plurality of context hints to the user.

According to an embodiment, the user terminal 100 may propose a hint according to a frequency of use. For example, when receiving (\textcircled{1}) a hint providing request from the intelligence agent 151, the hint providing module 155c_1 may transmit (\textcircled{2}) a hint generation request to the reuse hint generating module 155c_5. When receiving the hint generation request, the reuse hint generating module 155c_5 may receive (\textcircled{3}) user information from the persona module 155b. For example, the reuse hint generating module 155c_5 may receive a path rule included in preference information of the user of the persona module 155b, a parameter included in the path rule, a frequency of execution of an app, and space-time information used by the app. The reuse hint generating module 155c_5 may generate a hint corresponding to the received user information. The reuse hint generating module 155c_5 may transmit (\textcircled{4}) the generated hint to the hint providing module 155c_1. The hint providing module 155c_1 may arrange the hint and may transmit (\textcircled{5}) the hint to the intelligence agent 151.

According to an embodiment, the user terminal 100 may propose a hint for a new function. For example, when receiving (\textcircled{1}) a hint providing request from the intelligence agent 151, hint providing module 155c_1 may transmit (\textcircled{2}) a hint generation request to the introduction hint generating module 155c_6. The introduction hint generating module 155c_6 may transmit (\textcircled{3}) an introduction hint providing request to a proposal server 400 of FIG. 2 and may receive (\textcircled{4}) information about a function to be introduced from the proposal server 400. For example, the proposal server 400 may store information about a function to be introduced. A hint list of the function to be introduced may be updated by a service operator. The introduction hint generating module 155c_6 may transmit (\textcircled{5}) the generated hint to the hint providing module 155c1. The hint providing module 155c_1 may arrange the hint and may transmit (\textcircled{6}) the hint to the intelligence agent 151.

Thus, the proposal module 155c may provide the hint generated by the context hint generating module 155c_2, the reuse hint generating module 155c_5, or the introduction hint generating module 155c_6 to the user. For example, the proposal module 155c may display the generated hint on an app of operating the intelligence agent 151 and may receive an input for selecting the hint from the user through the app.

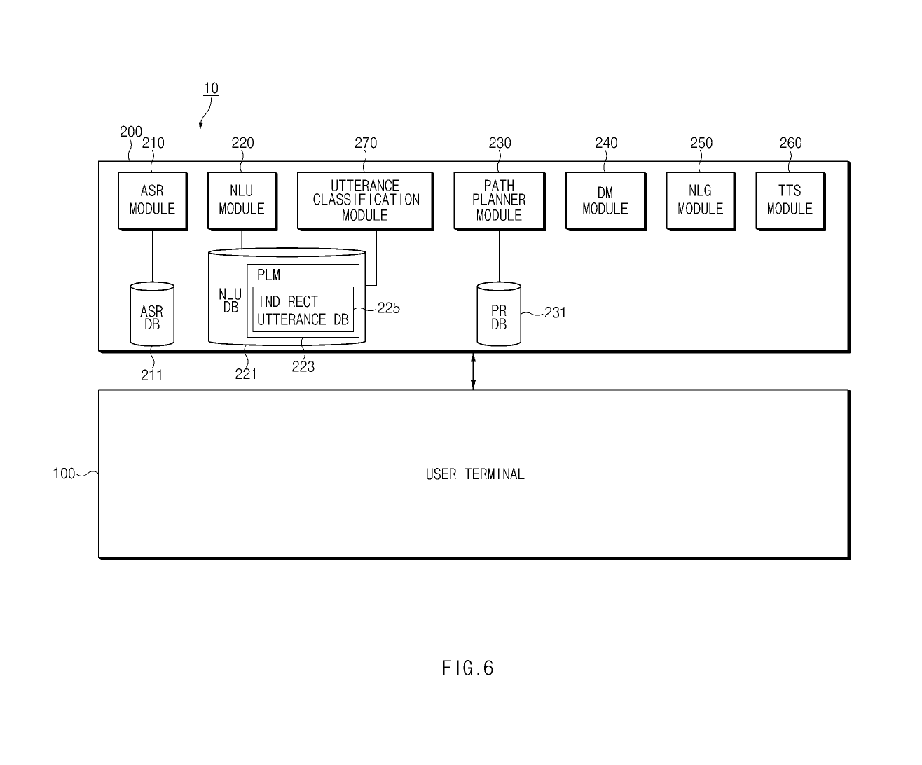

FIG. 6 is a block diagram illustrating an intelligence server of an integrated intelligent system according to an embodiment of the present disclosure.

Referring to FIG. 6, an intelligence server 200 may include an automatic speech recognition (ASR) module 210, a natural language understanding (NLU) module 220, a path planner module 230, a dialogue manager (DM) module 240, a natural language generator (NLG) module 250, a text to speech (TTS) module 260, or an utterance classification module 270.

The NLU module 220 or the path planner module 230 of the intelligence server 200 may generate a path rule.

According to an embodiment, the ASR module 210 may convert a user input (e.g., voice data) received from a user terminal 100 into text data. For example, the ASR module 210 may include an utterance recognition module. The utterance recognition module may include an acoustic model and a language model. For example, the acoustic model may include information associated with vocalization, and the language model may include unit phoneme information and information about a combination of unit phoneme information. The utterance recognition module may convert a user utterance (or voice data) into text data using the information associated with vocalization and information associated with a unit phoneme. For example, the information about the acoustic model and the language model may be stored in an ASR DB 211.

According to an embodiment, the NLU module 220 may perform a syntactic analysis or a semantic analysis to determine an intent of a user. The syntactic analysis may be used to divide a user input into a syntactic unit (e.g., a word, a phrase, a morpheme, or the like) and determine whether the divided unit has any syntactic element. The semantic analysis may be performed using semantic matching, rule matching, formula matching, or the like. Thus, the NLU module 220 may obtain a domain, intent, or a parameter (or a slot) utilizable to express the intent from a user input through the above-mentioned analysis.

According to an embodiment, the NLU module 220 may determine the intent of the user and a parameter using a matching rule which is divided into a domain, intent, and a parameter (or a slot). For example, one domain (e.g., an alarm) may include a plurality of intents (e.g., an alarm setting, alarm release, and the like), and one intent may need a plurality of parameters (e.g., a time, the number of iterations, an alarm sound, and the like). The plurality of rules may include, for example, one or more utilizable parameters. The matching rule may be stored in a NLU DB 221.

According to an embodiment, the NLU module 220 may determine a meaning of a word extracted from a user input using a linguistic feature (e.g., a syntactic element) such as a morpheme or a phrase and may match the determined meaning of the word to the domain and intent to determine the intent of the user. For example, the NLU module 220 may calculate how many words extracted from a user input are included in each of the domain and the intent, thus determining the intent of the user. According to an embodiment, the NLU module 220 may determine a parameter of the user input using a word which is the basis for determining the intent. According to an embodiment, the NLU module 220 may determine the intent of the user using the NLU DB 221 which stores the linguistic feature for determining the intent of the user input. According to another embodiment, the NLU module 220 may determine the intent of the user using a personal language model (PLM). For example, the NLU module 220 may determine the intent of the user using personalized information (e.g., a contact list or a music list). For example, the PLM may be stored in, for example, the NLU DB 221. According to an embodiment, the ASR module 210 as well as the NLU module 220 may recognize a voice of the user with reference to the PLM stored in the NLU DB 221.

According to an embodiment, the NLU module 220 may generate a path rule based on an intent of a user input and a parameter. For example, the NLU module 220 may select an app to be executed, based on the intent of the user input and may determine an action to be executed in the selected app. The NLU module 220 may determine a parameter corresponding to the determined action to generate the path rule. According to an embodiment, the path rule generated by the NLU module 220 may include information about an app to be executed, an action (e.g., at least one or more states) to be executed in the app, and a parameter utilizable to execute the action.

According to an embodiment, the NLU module 220 may generate one path rule or a plurality of path rules based on the intent of the user input and the parameter. For example, the NLU module 220 may receive a path rule set corresponding to a user terminal 100 from the path planner module 230 and may map the intent of the user input and the parameter to the received path rule set to determine the path rule.

According to another embodiment, the NLU module 220 may determine an app to be executed, an action to be executed in the app, and a parameter utilizable to execute the action, based on the intent of the user input and the parameter to generate one path rule or a plurality of path rules. For example, the NLU module 220 may arrange the app to be executed and the action to be executed in the app in the form of ontology or a graph model depending on the intent of the user input using information of the user terminal 100 to generate the path rule. The generated path rule may be stored in, for example, a path rule database (PR DB) 231 through the path planner module 230. The generated path rule may be added to a path rule set stored in the PR DB 231.

According to an embodiment, the NLU module 220 may select at least one of a plurality of generated path rules. For example, the NLU module 220 may select an optimal path rule among the plurality of path rules. For another example, when some actions are specified based on a user utterance, the NLU module 220 may select a plurality of path rules. The NLU module 220 may determine one of the plurality of path rules depending on an additional input of the user.

According to an embodiment, the NLU module 220 may transmit the path rule to the user terminal 100 in response to a request for a user input. For example, the NLU module 220 may transmit one path rule corresponding to the user input to the user terminal 100. For another example, the NLU module 220 may transmit the plurality of path rules corresponding to the user input to the user terminal 100. For example, when some actions are specified based on a user utterance, the plurality of path rules may be generated by the NLU module 220.

According to an embodiment, the path planner module 230 may select at least one of the plurality of path rules.

According to an embodiment, the path planner module 230 may transmit a path rule set including the plurality of path rules to the NLU module 220. The plurality of path rules included in the path rule set may be stored in the PR DB 231 connected to the path planner module 230 in the form of a table. For example, the path planner module 230 may transmit a path rule set corresponding to information (e.g., Operating System (OS) information, app information, or the like) of the user terminal 100, received from an intelligence agent 151 of FIG. 2, to the NLU module 220. A table stored in the PR DB 231 may be stored for, for example, each domain or each version of the domain.

According to an embodiment, the path planner module 230 may select one path rule or a plurality of path rules from a path rule set to transmit the selected one path rule or the plurality of selected path rules to the NLU module 220. For example, the path planner module 230 may match an intent of the user and a parameter to a path rule set corresponding to the user terminal 100 to select one path rule or a plurality of path rules and may transmit the selected one path rule or the plurality of selected path rules to the NLU module 220.

According to an embodiment, the path planner module 230 may generate one path rule or a plurality of path rules using the intent of the user and the parameter. For example, the path planner module 230 may determine an app to be executed and an action to be executed in the app, based on the intent of the user and the parameter to generate the one path rule or the plurality of path rules. According to an embodiment, the path planner module 230 may store the generated path rule in the PR DB 231.

According to an embodiment, the path planner module 230 may store a path rule generated by the NLU module 220 in the PR DB 231. The generated path rule may be added to a path rule set stored in the PR DB 231.

According to an embodiment, the table stored in the PR DB 231 may include a plurality of path rules or a plurality of path rule sets. The plurality of path rules or the plurality of path rule sets may reflect a kind, version, type, or characteristic of a device which performs each path rule.

According to an embodiment, the DM module 240 may determine whether the intent of the user, determined by the NLU module 220, is clear. For example, the DM module 240 may determine whether the intent of the user is clear, based on whether information of a parameter is sufficient. The DM module 240 may determine whether the parameter determined by the NLU module 220 is sufficient to perform a task. According to an embodiment, when the intent of the user is not clear, the DM module 240 may perform feedback for requesting information utilizable for the user. For example, the DM module 240 may perform feedback for requesting information about a parameter for determining the intent of the user.

According to an embodiment, the DM module 240 may include a content provider module. When the content provider module performs an action based on the intent and the parameter determined by the NLU module 220, it may generate the result of performing a task corresponding to a user input. According to an embodiment, the DM module 240 may transmit the result generated by the content provider module as a response to the user input to the user terminal 100.

According to an embodiment, the NLG module 250 may change specified information in the form of text. Information changed to the text form may be a form of a natural language utterance. The information changed in the form of text may have a form of a natural language utterance. The specified information may be, for example, information about an additional input, information for providing a notification that an action corresponding to a user input is completed, or information for providing a notification of the additional input of the user (e.g., information about feedback on the user input). The information changed in the form of text may be transmitted to the user terminal 100 to be displayed on a display 120 FIG. 2 or may be transmitted to the TTS module 260 to be changed in the form of a voice.

According to an embodiment, the TTS module 260 may change information of a text form to information of a voice form. The TTS module 260 may receive the information of the text form from the NLG module 250 and may change the information of the text form to the information of the voice form, thus transmitting the information of the voice form to the user terminal 100. The user terminal 100 may output the information of the voice form through a speaker 130 of FIG. 2.

According to an embodiment, the NLU module 220, the path planner module 230, and the DM module 240 may be implemented as one module. For example, the NLU module 220, the path planner module 230 and the DM module 240 may be implemented as the one module to determine an intent of the user and a parameter and generate a response (e.g., a path rule) corresponding to the determined intent of the user and the determined parameter. Thus, the generated response may be transmitted to the user terminal 100.

According to an embodiment, the utterance classification module 270 may classify an utterance of the user. For example, the utterance classification module 270 may classify text data obtained by converting voice data obtained in response to an utterance input of the user into a text format through the ASR module 210. According to an embodiment, the utterance classification module 270 may classify at least one expression included in the text data. For example, the utterance classification module 270 may perform a linguistic analysis (e.g., a syntactic analysis or a semantic analysis) for the text data through the NLU module 220 and may extract at least one expression from the text data based on the performed result. Further, the utterance classification module 270 may determine (or classify) whether the at least one extracted expression is an explicit expression (or a direct expression) or an inexplicit expression (or an indirect expression).

According to an embodiment, the explicit expression may include an expression of explicitly requesting to perform a task. For example, the explicit expression may include an essential element (e.g., a domain, intent, or the like) utilizable to perform the task. For example, the explicit expression may include an identifier of an executable application, instructions configured to execute a function (or an action) of the application, or the like. The inexplicit expression may include an expression except for the explicit expression. For example, the inexplicit expression may include an additional element (e.g., parameter information) used while the task is performed or an unnecessary element (e.g., an exclamation or the like) irrespective of performing the task. In some embodiments, the explicit expression may further include the parameter information. In another embodiment, the explicit expression may include an expression capable of matching a path rule, reliability of which is greater than or equal to a threshold, and the inexplicit expression may include an expression incapable of matching the path rule, the reliability of which is greater than or equal to the threshold.

According to an embodiment, the utterance classification module 270 may classify at least one expression included in the text data as the explicit expression or the inexplicit expression.

According to an embodiment, when the explicit expression is included in the text data, the utterance classification module 270 may transmit the explicit expression to a response generator module (e.g., the NLU module 220, the path planner module 230, or the DM module 240). The response generator module may determine an intent of the user (and a parameter) based on the explicit expression and may generate (or select) a response (e.g., a path rule) corresponding to the determined intent of the user (and the determined parameter). In some embodiments, when an additional element (e.g., parameter information) utilizable to perform a task in the inexplicit expression is included together with the explicit expression, the utterance classification module 270 may transmit the explicit expression and the additional element to the response generator module. The response generator module may determine an intent of the user and a parameter based on the explicit expression and the additional element and may generate (or select) a response (e.g., a path rule) corresponding to the determined intent of the user and the determined parameter.

According to an embodiment, when both the explicit expression and the inexplicit expression are included in the text data, the utterance classification module 270 may map and store the explicit expression and the inexplicit expression (e.g., an additional element or an unnecessary element) in an indirect utterance DB 225 included in the PLM 223. In some embodiments, the utterance classification module 270 may map the explicit expression to an identifier (e.g., a path rule number) of a response (e.g., a path rule) generated (or selected) through the response generator module and/or the explicit expression to store the mapping information in the indirect utterance DB 225. Thus, the intelligence server 200 may train an ability to perform a task with respect to the inexplicit expression.

According to an embodiment, when the explicit expression is not included in the text data and when the inexplicit expression is included in the text data, for example, when an utterance of the user is an inexplicit utterance (or an indirect utterance), the utterance classification module 270 may verify whether there is an explicit expression and/or a path rule number mapped with the inexplicit expression in the indirect utterance DB 225. When there is the explicit expression and/or the path rule number mapped with the inexplicit expression, the utterance classification module 270 may transmit the explicit expression and/or the path rule number to the response generator module. The response generator module may generate (or select) a path rule based on the explicit expression and/or the path rule number.

According to an embodiment, when an utterance of the user is an inexplicit utterance and when there are a plurality of explicit expressions (or a plurality of path rule numbers) mapped with the inexplicit expression in the indirect utterance DB 255, the utterance classification module 270 may transmit the plurality of explicit expressions (or the plurality of path rule numbers) to the response generator module. The response generator module may generate (or select) path rules associated with performing each task based on the plurality of explicit expressions (or the plurality of path rule numbers). In some embodiments, the intelligence server 200 may generate hint information associated with performing each task corresponding to each of the explicit expressions (or the path rule numbers) and may transmit the hint information to the user terminal 100.

According to an embodiment, when an utterance of the user is an inexplicit utterance and when there are a plurality of inexplicit expressions, the utterance classification module 270 may verify whether there are explicit expressions (or path rule numbers) respectively mapped to the inexplicit expressions in the indirect utterance DB 255. Alternatively, when there are the explicit expressions (or the path rule numbers) respectively mapped to the inexplicit expressions, the utterance classification module 270 may transmit the explicit expressions (or the path rule numbers) to the response generator module. The response generator module may generate (or select) path rules associated with performing each task based on the explicit expressions (or the path rule numbers). In another example, the intelligence server 200 may generate hint information associated with performing each task corresponding to each of the explicit expressions (or the path rule numbers) and may transmit the hint information to the user terminal 100. In another embodiment, the intelligence server 200 may select any one of the explicit expressions (or the selected path rule numbers) and may generate (or select) a path rule using the selected explicit expression (or the selected path rule number). For example, the intelligence server 200 may select any one of the explicit expressions based on priorities of inexplicit expressions respectively corresponding to the explicit expressions. The priorities may be determined by at least one of, for example, the number of the implicit expressions respectively mapped to the implicit expressions, a frequency of use of the implicit expressions, or user information.

According to an embodiment, an inexplicit expression and an explicit expression spoken together with the inexplicit expression may be mapped and stored in the indirect utterance DB 225. In some embodiments, an inexplicit expression, an explicit expression spoken together with the inexplicit expression, and a number of a path rule generated (or selected) based on the explicit expression may be mapped and stored in the indirect utterance DB 225.

According to an embodiment, the indirect utterance DB 225 may be stored in the intelligence server 200 or may be stored in the user terminal 100. When the indirect utterance DB 225 is stored in the user terminal 100, the intelligence server 200 may receive and use information (e.g., mapping information) stored in the indirect utterance DB 225 from the user terminal 100.

According to an embodiment, the indirect utterance DB 225 may be used for modeling of the PLM 223. In another embodiment, when there are a plurality of path rules generated (or selected) based on an explicit expression, information (e.g., mapping information) stored in the indirect utterance DB 225 may be used when any one of the plurality of path rules is selected. For example, when there are a plurality of path rules generated (or selected) based on one explicit expression, the response generator module may adjust a reliability value (or a priority) for each of the plurality of path rules using information of inexplicit expressions mapped with the explicit expression stored in the indirect utterance DB 225. The response generator module may select any one of the plurality of path rules based on the reliability value (or the priority).

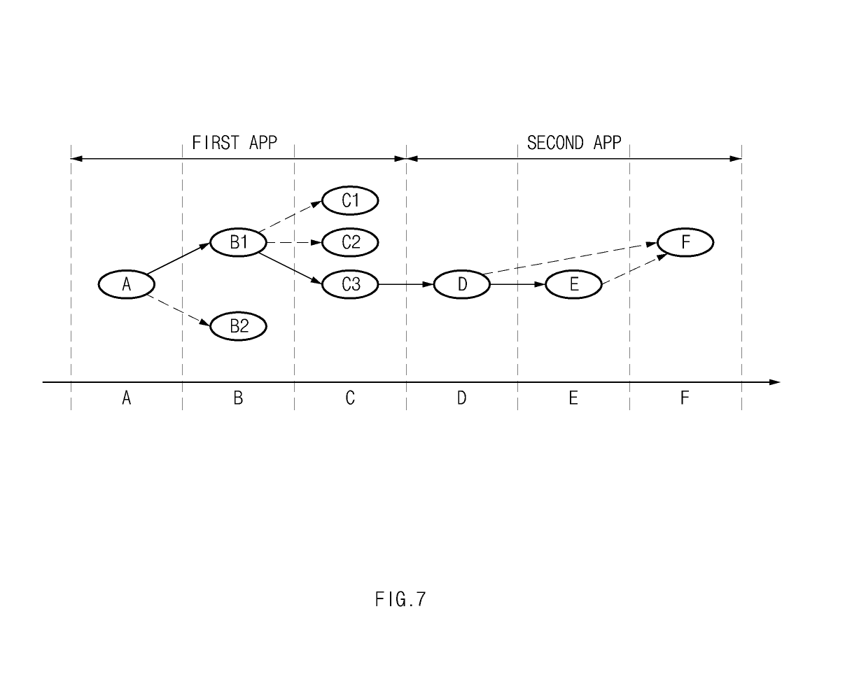

FIG. 7 is a drawing illustrating a method for generating a path rule at a path planner module according to an embodiment of the present disclosure.

Referring to FIG. 7, according to an embodiment, an NLU module 220 of FIG. 6 may classify a function of an app into any one of actions (e.g., state A to state F) and may store the divided action in a PR DB 231 of FIG. 6. For example, the NLU module 220 may store a path rule set, including a plurality of path rules (e.g., a first path rule A-B1-C1, a second path rule A-B1-C2, a third path rule A-B1-C3-D-F, and a fourth path rule A-B1-C3-D-E-F) classified as one action (e.g., state), in the PR DB 231.

According to an embodiment, the PR DB 231 of a path planner module 230 of FIG. 6 may store a path rule set for performing the function of the app. The path rule set may include a plurality of path rules, each of which includes a plurality of actions (e.g., a sequence of states). An action executed depending on a parameter input to each of the plurality of actions may be sequentially arranged in the plurality of path rules. According to an embodiment, the plurality of path rules may be configured in the form of ontology or a graph model to be stored in the PR DB 231.

According to an embodiment, the NLU module 220 may select an optimal path rule (e.g., the third path rule A-B1-C3-D-F) among the plurality of path rules (e.g., the first path rule A-B1-C1, the second path rule A-B1-C2, the third path rule A-B1-C3-D-F, and the fourth path rule A-B1-C3-D-E-F) corresponding to an intent of a user input and a parameter.

According to an embodiment, when there is no path rule completely matched to a user input, the NLU module 220 may transmit a plurality of rules to a user terminal 100 of FIG. 6. For example, the NLU module 220 may select a path rule (e.g., a fifth path rule A-B1) partially corresponding to the user input. The NLU module 220 may select one or more path rules (e.g., the first path rule A-B1-C1, the second path rule A-B1-C2, the third path rule A-B1-C3-D-F, and the fourth path rule A-B1-C3-D-E-F) including the path rule (e.g., the fifth path rule A-B1) partially corresponding to the user input and may transmit the one or more path rules to the user terminal 100.

According to an embodiment, the NLU module 220 may select one of a plurality of path rules based on an additional input of the user terminal 100 and may transmit the selected one path rule to the user terminal 100. For example, the NLU module 220 may select one (e.g., the third path rule A-B1-C3-D-F) of the plurality of path rules (e.g., the first path rule A-B1-C1, the second path rule A-B1-C2, the third path rule A-B1-C3-D-F, and the fourth path rule A-B1-C3-D-E-F) depending on a user input (e.g., an input for selecting C3) additionally input to the user terminal 100, thus transmitting the selected one path rule to the user terminal 100.

According to another embodiment, the NLU module 220 may determine an intent of the user and a parameter corresponding to the user input (e.g., the input for selecting C3) additionally input to the user terminal 100, thus transmitting the determined intent of the user or the determined parameter to the user terminal 100. The user terminal 100 may select one (e.g., the third path rule A-B1-C3-D-F) of the plurality of path rules (e.g., the first path rule A-B1-C1, the second path rule A-B1-C2, the third path rule A-B1-C3-D-F, and the fourth path rule A-B1-C3-D-E-F) based on the transmitted intent or parameter.

Thus, the user terminal 100 may complete the actions of the apps 141 and 143 based on the selected one path rule.

According to an embodiment, when a user input, information of which is insufficient, is received at an intelligence server 200 of FIG. 6, the NLU module 220 may generate a path rule partially corresponding to the received user input. For example, the NLU module 220 may transmit the partially corresponding path rule to an intelligence agent 151 of FIG. 2. The intelligence agent 151 may transmit the partially corresponding path rule to an execution manager module 153 of FIG. 2, and the execution manager module 153 may execute a first app 141 of FIG. 2 depending on the path rule. The execution manager module 153 may transmit information about an insufficient parameter to the intelligence agent 151 while executing the first app 141. The intelligence agent 151 may request a user to provide an additional input using the information about the insufficient parameter. When the additional input is received by the user, the intelligence agent 151 may transmit the additional input to the intelligence server 200. The NLU module 220 may generate an added path rule based on information about an intent of the user input which is additionally input and a parameter and may transmit the generated path rule to the intelligence agent 151. The intelligence agent 151 may transmit the path rule to an execution manager module 153 of FIG. 2, and the execution manager module 153 may execute a second app 143 of FIG. 2 depending on the added path rule.

According to an embodiment, when a user input, some information of which is missed, is received at the intelligence server 200, the NLU module 220 may transmit a user information request to a personal information server 300 of FIG. 2. The personal information server 300 may transmit user information stored in a persona DB to the NLU module 220. The NLU module 220 may select a path rule corresponding to the user input, some actions of which are missed, using the user information. Thus, even though the user input, some information of which is missed, is received at the intelligence server 200, the NLU module 220 may request the user to provide the missed information to receive an additional input or may determine a path rule corresponding to the user input using the user information.

Table 1 below may indicate an example form of a path rule associated with a task requested by the user according to an embodiment.

TABLE 1

| Path rule ID | State | Parameter |
|---|---|---|
| Gallery_101 | PicturesView(25) | NULL |
| | SearchView(26) | NULL |
| | SearchViewResult(27) | Location, time |
| | SearchEmptySelectedView(28) | NULL |
| | SearchSelectedView(29) | ContentType, selectall |
| | CrossShare(30) | anaphora |

Referring to Table 1, a path rule generated or selected by an intelligence server (e.g., an intelligence server 200 of FIG. 1) depending on a user utterance (e.g., “Please share your photo with me”) may include at least one state 25, 26, 27, 28, 29, or 30. For example, the at least one state (e.g., one action state of a user terminal 100 of FIG. 1) may correspond to at least one of PicturesView 25, SearchView 26, SearchViewResult 27, SearchEmptySelectedView 28, SearchSelectedView 29, or Cross Share 30.

In an embodiment, information about a parameter of the path rule may correspond to at least one state. For example, the information about the parameter of the path rule may be included in SearchSelectedView 29.

A task (e.g., “Please share your photo with me!”) requested by a user may be performed as a result of performing a path rule including a sequence of the states 25 to 29.

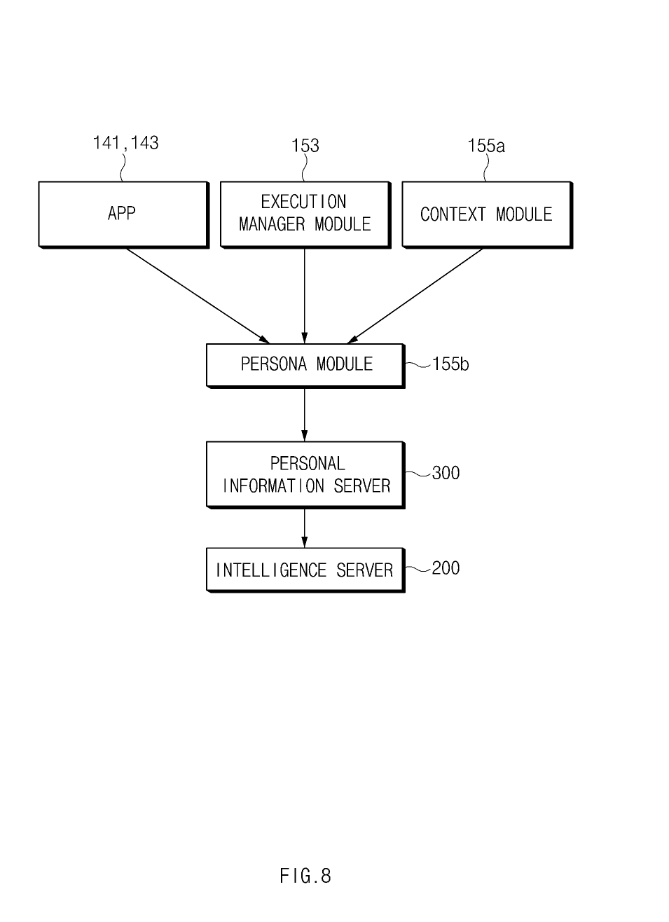

FIG. 8 is a block diagram illustrating a method for managing user information at a persona module of an intelligence service module according to an embodiment of the present disclosure.

Referring to FIG. 8, a persona module 155b may receive information of a user terminal 100 of FIG. 2 from apps 141 and 143, an execution manager module 153, or a context module 155a. The apps 141 and 143 and the execution manager module 153 may store information about the result of executing actions 141b and 143b of the apps 141 and 143 in an operation log DB. The context module 155a may store information about a current state of the user terminal 100 in a context DB. The persona module 155b may receive the stored information from the operation log DB or the context DB. Data stored in the operation log DB and the context DB may be analyzed by, for example, an analysis engine to be transmitted to the persona module 155b.

According to an embodiment, the persona module 155b may transmit information, received from the apps 141 and 143, the execution manager module 153, or the context module 155a, to a proposal module 155c of FIG. 2. For example, the persona module 155b may transmit data stored in the operation log DB or the context DB to the proposal module 155c.

According to an embodiment, the persona module 155b may transmit information, received from the apps 141 and 143, the execution manager module 153, or the context module 155a, to a personal information server 300. For example, the persona module 155b may periodically transmit data accumulated and stored in the operation log DB or the context DB to the personal information server 300.

According to an embodiment, the persona module 155b may transmit data stored in the operation log DB or the context DB to the proposal module 155c. User information generated by the persona module 155b may be stored in a persona DB. The persona module 155b may periodically transmit the user information stored in the persona DB to the personal information server 300. According to an embodiment, the information transmitted to the personal information server 300 by the persona module 155b may be stored in the personal DB. The personal information server 300 may infer user information utilizable to generate a path rule of an intelligence server 200 using the information stored in the persona DB.

According to an embodiment, user information inferred using information transmitted by the persona module 155b may include profile information or preference information. The profile information or the preference information may be inferred from an account of a user and accumulated information.

The profile information may include personal information of the user. For example, the profile information may include information about popular statistics of the user. The information about the popular statistics may include, for example, a gender, an age, or the like of the user. For another example, the profile information may include life event information. The life event information may be inferred by comparing, for example, log information with a life event model and may reinforce by analyzing a behavior pattern. For another example, the profile information may be interest information. The interest information may include, for example, information about an interest shopping product, an interest field (e.g., sports, politics, or the like). For another example, the profile information may include information about an activity area. The information about the activity area may include, for example, information about home, a working place, or the like. The information about the activity area may include information about an area with a recorded priority with reference to an accumulated time of stay and the number of visits as well as information about a location of a place. For another example, the profile information may include information about an activity time. The information about the activity time may include, for example, information about a wake-up time, a commute time, or a sleep time. Information about the commute time may be inferred using information about the activity area (e.g., home and a working place). Information about the sleep time may be inferred from a time when the user terminal 100 is not used.

The preference information may include information about a preference of the user. For example, the preference information may include information about an app preference. The app preference may be inferred from, for example, a usage record of an app (e.g., a usage record for each time or place). The app preference may be used to determine an app to be executed according to a current state (e.g., time or a place) of the user. For another example, the preference information may include information about contact preference. The contact preference may be inferred by analyzing, for example, information about contact frequency of contact information (e.g., contact frequency for each time or place). The contact preference may be used to determine contact information (e.g., a duplicated name) to which the user will make a call depending on a current state of the user. For another example, the preference information may include setting information. The setting information may be inferred by analyzing, for example, information about a setting frequency of a specific setting value (e.g., frequency set to a setting value for each time or place). The setting information may be used to set the specific setting value depending on a current state (e.g., time, a place, or a situation) of the user. For another example, the preference information may include a place preference. The place preference may be inferred from, for example, visit records of a specific place (e.g., visit records for each time). The place preference may be used to determine a place which is visited according of a current state (e.g., time) of the user. For another example, the preference information may include a command preference. The command preference may be inferred from, example, a frequency of use of a command (e.g., a frequency of use for each time or place). The command preference may be used to determine a command pattern to be used according to a current state (e.g., time or a place) of the user. Particularly, the command preference may include information about a menu which is most frequently selected by the user, based on analyzed log information, in a current state of an app which is being executed.

As described above, according to various embodiments, an electronic device (e.g., the intelligence server 200, the personal information server 300, or the proposal server 400) may include a network interface, at least one processor configured to be operatively connected with the network interface, and at least one memory configured to be operatively connected with the at least one processor. The at least one memory may store instructions, when executed, causing the at least one processor to: in a first operation, receive first data associated with a first user input obtained through a first external device (e.g., the user terminal 100), from the first external device including a microphone, through the network interface, the first user input including an explicit request for performing a task using at least one of the first external device or the second external device, verify a first intent from the first user input through natural understanding processing, determine a sequence of states of at least one of the first external device or the second external device for performing the task, based at least in part on the first intent, and transmit first information about the sequence of the states to at least one of the first external device or the second external device via the network interface, in second operation, receive second data associated with a second user input obtained through the first external device, from the first external device through the network interface, the second user input including a natural language expression of hinting a request for performing the task, verify the first intent from the natural language expression, based at least in part on natural language expressions previously provided to the electronic device, determine a sequence of the states of at least one of the first external device or the second external device for performing the task, based at least in part on the first intent, and transmit second information of the sequence of the states to at least one of the first external device or the second external device via the network interface.

According to various embodiments, the instructions may cause the at least one processor to store the natural language expressions previously provided to the electronic device in a database (DB).

According to various embodiments, the instructions may cause the at least one processor to: in a third operation, receive third data associated with a third user input obtained through the first external device, from the first external device through the network interface, the third user input including another natural language expression of hinting the request for performing the task, determine whether there is a match between a previously stored sequence of at least one of states of at least one of the first external device or the second external device for performing the task and the other natural language expression, and store the other natural language expression in the DB based at least in part on whether there is the match.

According to various embodiments, the instructions may cause the at least one processor to: in the third operation, determine a score indicating whether there is the match between the other natural language expression and the previously stored sequence of states, and when the score is not greater than a selected threshold, store the other natural language expression in the DB.

According to various embodiments, the electronic device may include a communication circuit, at least one processor configured to be operatively connected with the communication circuit, and at least one memory configured to be operatively connected with the at least one processor. The at least one memory may store instructions, when executed, causing the at least one processor to obtain voice data from an external device via the communication circuit, convert the voice data into text data, classify at least one expression included in the text data, when the at least one expression includes a first expression for requesting to perform a first task using the external device, transmit first information about a sequence of states of the external device associated with performing the first task to the external device via the communication circuit, and when the at least one expression does not include the first expression and includes a second expression different from the first expression and when there is the first expression mapped with the second expression in a DB, transmit the first information to the external device via the communication circuit.

According to various embodiments, the first expression may include at least one of an identifier of an application executable by the external device and a command set to execute a function of the application.

According to various embodiments, the at least one memory may store instructions, when executed, causing the at least one processor to map at least one of the first expression and second information associated with the first task to the second expression and store the mapping information, when the at least one expression includes the first expression and the second expression.

According to various embodiments, the at least one memory may store instructions, when executed, causing the at least one processor to transmit first hint information associated with performing the first task corresponding to the first expression and at least one second hint information associated with performing at least one second task corresponding to at least one third expression to the external device, when the at least one expression does not include the first expression and includes the second expression different from the first expression and when there are the first expression mapped with the second expression and the at least one third expression different from the first expression in the DB.

According to various embodiments, the at least one memory may store instructions, when executed, causing the at least one processor to designate an order where the first hint information and the at least one second hint information are displayed, based on priorities of the first expression and the at least one third expression.

According to various embodiments, the at least one memory may store instructions, when executed, causing the at least one processor to select any one of the first expression and at least one third expression based on priorities of the first expression and the at least one third expression and transmit information about a sequence of states of the external device associated with performing a task corresponding to the selected expression to the external device, when the at least one expression does not include the first expression and includes the second expression different from the first expression and when there are the first expression mapped with the second expression and the at least one third expression different from the first expression in the DB.

According to various embodiments, the at least one memory may store instructions, when executed, causing the at least one processor to transmit first hint information associated with performing the first task corresponding to the first expression and at least one second hint information associated with performing at least one second task corresponding to at least one fourth expression to the external device, when the at least one expression does not include the first expression and includes the second expression and at least one third expression, which are different from the first expression, and when there are the first expression mapped with the second expression and the at least one fourth expression mapped with the at least one third expression in the DB.

According to various embodiments, the at least one memory may store instructions, when executed, causing the at least one processor to designate an order where the first hint information and the at least one second hint information are displayed, based on priorities of the first expression and the at least one fourth expression.

According to various embodiments, the at least one memory may store instructions, when executed, causing the at least one processor to select any one of the first expression and at least one fourth expression based on priorities of the first expression and the at least one fourth expression and transmit information about a sequence of states of the external device associated with performing a task corresponding to the selected expression to the external device, when the at least one expression does not include the first expression and includes the second expression and at least one third expression, which are different from the first expression, and when there are the first expression mapped with the second expression and the at least one fourth expression mapped with the at least one third expression in the DB.

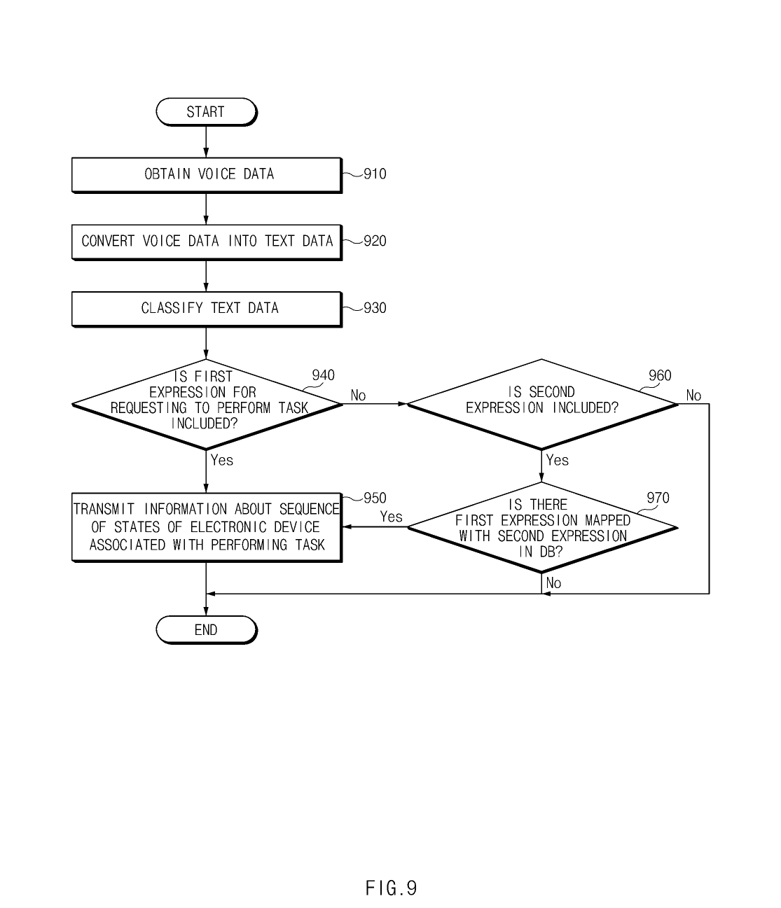

FIG. 9 is a flowchart illustrating an operation method of a system associated with processing voice data according to an embodiment of the present disclosure.

Referring to FIG. 9, in operation 910, a system (e.g., an intelligence server 200 of FIG. 6) may obtain voice data. According to an embodiment, the intelligence server 200 may obtain voice data corresponding to an utterance input (i.e., a voice input or voice command) of the user as transmitted from an external device (e.g., a user terminal 100 of FIG. 6).

In operation 920, the system may convert the obtained voice data into text data. According to an embodiment, an ASR module 210 of the intelligence server 200 may convert voice data received from the user terminal 100 into text data by extracting text data via acoustic-based recognition of the words in the voice data. For example, the ASR module 210 may convert voice data into text data using information associated with vocalization and information associated with a unit phoneme.

In operation 930, the system may classify the converted text data. According to an embodiment, an utterance classification module 270 of the intelligence server 200 may classify at least one expression included in the text data, such as a commanding word, phrase, utterance, or combination of words, etc. For example, the utterance classification module 270 may determine whether the at least one expression is an explicit expression (or a direct expression) for explicitly requesting to perform a task or an inexplicit expression (or an indirect expression) and may classify the at least one expression.

In operation 940, the system may determine whether a first expression (e.g., an explicit expression or a direct expression) for requesting to perform a task is included in the extracted text data. According to an embodiment, the utterance classification module 270 of the intelligence server 200 may determine whether an explicit expression for explicitly requesting to perform the task is included in the at least one expression included in the text data. In other words, the system may determine whether an utterance of the user is an explicit utterance (or a direct utterance) based on comparison against a prestored set of known expressions for voice commands, as mapped to a number of corresponding executable functions respectively.

When the utterance of the user is the explicit utterance (i.e., when the first expression for requesting to perform the task is included in the text data), in operation 950, the system may transmit information (e.g., a path rule) regarding a sequence of states of an external device (e.g., the user terminal 100) associated with performing the task to the external device. According to an embodiment, the utterance classification module 270 may transmit an explicit expression included in the text data to a response generator module (e.g., an NLU module 220, a path planner module 230, or a DM module 240) of the intelligence server 200. The response generator module may determine an intent of the user based on the explicit expression and may generate (or select) a response (e.g., a path rule) corresponding to the determined intent of the user, thus transmitting the response to the external device. In another embodiment, when an additional element (e.g., parameter information) utilizable to perform the task is included together with an explicit expression in the text data, the utterance classification module 270 may transmit the additional element in an inexplicit expression together with the explicit expression to the response generator module. In this case, the response generator module may determine an intent of the user and a parameter based on the explicit expression and/or the additional element and may generate (or select) a response (e.g., a path rule) corresponding to the determined intent of the user and the determined parameter, thus transmitting the response to the external device.

When an utterance of the user is an inexplicit utterance (or an indirect utterance), that is, when there is no explicit expression for explicitly requesting to perform the task in the text data that is known and stored in memory, in operation 960, the system may determine whether a second expression (e.g., an inexplicit expression or an indirect expression) is included in the text data, by comparison against another set of prestored expressions indicated as inexplicit. When the second expression is included in the text data, in operation 970, the system may determine whether there is the first expression mapped with the second expression in a DB (e.g., an indirect utterance DB 225 of FIG. 6). According to an embodiment, the utterance classification module 270 may determine whether there is an explicit expression mapped with an inexplicit expression in the indirect utterance DB 225. In some embodiments, the utterance classification module 270 may determine whether there is a path rule number mapped with an inexplicit expression in the indirect utterance DB 225.

When there is the explicit expression (or the path rule number) mapped to the inexplicit expression in the indirect utterance DB 225, the system may perform operation 950. For example, there is the explicit expression (or the path rule number) mapped to the inexplicit expression in the indirect utterance DB 225, in operation 950, the utterance classification module 270 may transmit the explicit expression (or the path rule number) to the response generator module. The response generator module may generate (or select) a path rule based on the explicit expression (or the path rule number) and may transmit the path rule to the external device.

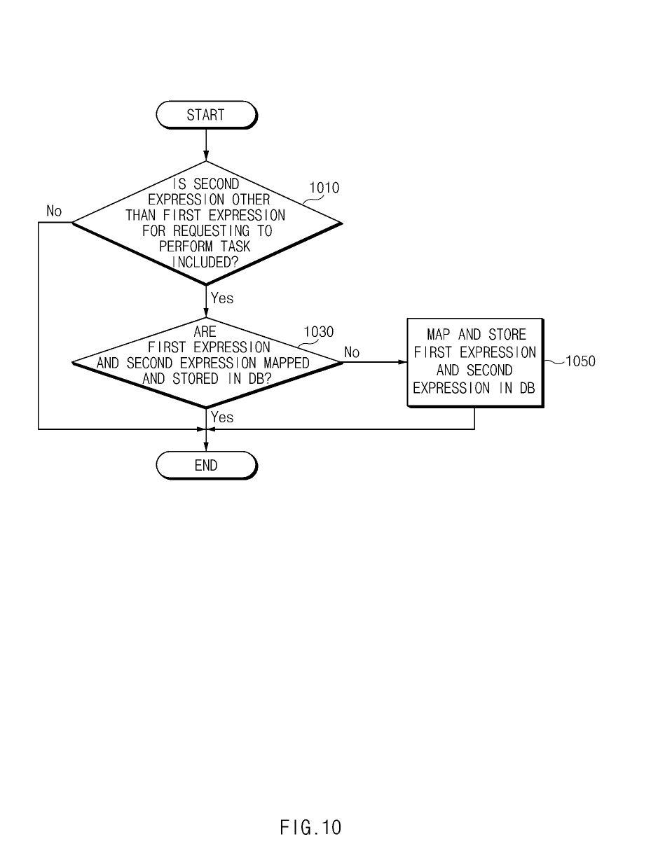

According to various embodiments, a user who is not familiar with using a device or is not familiar with performing a function of the device using his or her utterance input may execute a specific function using his or her utterance input. In this case, although the user does not provide an explicit utterance for explicitly executing the specific function, when an inexplicit expression mapped to an explicit expression for explicitly executing the specific function is stored in a DB, the user may expect that the specified function is executed by an inexplicit utterance including the inexplicit expression. For this purpose, the system may need a training process of mapping the explicit expression and the inexplicit expression. A description will be given of the training process with reference to FIG. 10.

FIG. 10 is a flowchart illustrating an operation method of a system associated with training an inexplicit utterance according to an embodiment of the present disclosure.

Referring to FIG. 10, a system (e.g., an intelligence server 200 of FIG. 6) may ‘train’ in recognition of an inexplicit utterance (or an indirect utterance). According to an embodiment, an ASR module 210 of the intelligence server 200 may obtain voice data corresponding to an utterance input by a user from a user terminal 100 of FIG. 6 and may convert the obtained voice data into text data. According to an embodiment, an utterance classification module 270 of the intelligence server 200 may classify at least one expression included in the text data. For example, the utterance classification module 270 may determine whether the at least one expression is an explicit expression (or a direct expression) for explicitly requesting to perform a task or an inexplicit expression (or an indirect expression) to classify the at least one expression.

When the process of classifying the expression included in the text data is completed, in operation 1010, the system may determine whether a second expression (e.g., an inexplicit expression or an indirect expression) other than a first expression (e.g., an explicit expression or a direct expression) for requesting performance of the task is included. For example, the utterance classification module 270 of the intelligence server 200 may verify whether the first expression and the second expression are both included in the text data.

When the first expression and the second expression are included in the text data, in operation 1030, the system may determine whether the first expression and the second expression are mapped and stored in a DB (e.g., an indirect utterance DB 225 of FIG. 6). For example, the utterance classification module 270 may verify whether the explicit expression and the inexplicit expression included in the text data are mapped and stored in the indirect utterance DB 225.

According to an embodiment, when the first expression and the second expression are both already mapped and stored in the indirect utterance DB 225, the system may maintain a state where the first expression and the second expression are stored. According to an embodiment, when the first expression and the second expression are not mapped and stored in the indirect utterance DB 225, in operation 1050, the system may map and store the first expression and the second expression in the DB. For example, the utterance classification module 270 may map and store the explicit expression and the inexplicit expression as a classification of an indirect utterance DB 225.

Through the above-mentioned process, although the inexplicit expression is included in the text data, that is, although an utterance of the user is an inexplicit utterance, the system according to various embodiments of the present disclosure may perform a task corresponding to an explicit expression mapped with the inexplicit expression. For example, the system may train an ability to perform a task with respect to the inexplicit expression by repeating the above-mentioned process. Alternatively, the system may adjust a weight of a path rule candidate group capable of being generated (or selected) by a response generator module using mapping information between the explicit expression and the inexplicit expression stored in the indirect utterance DB 225. In other words, the mapping information may be used for enhancing accuracy of generating (or selecting) a path rule in case of the explicit utterance as well as for searching for and/or referring to a path rule number in case of the inexplicit expression. For example, the system may adjust a reliability value (or a priority) for each of a plurality of path rules with reference to the indirect utterance DB 225 and may select any one of the plurality of path rules based on the reliability value (or the priority).

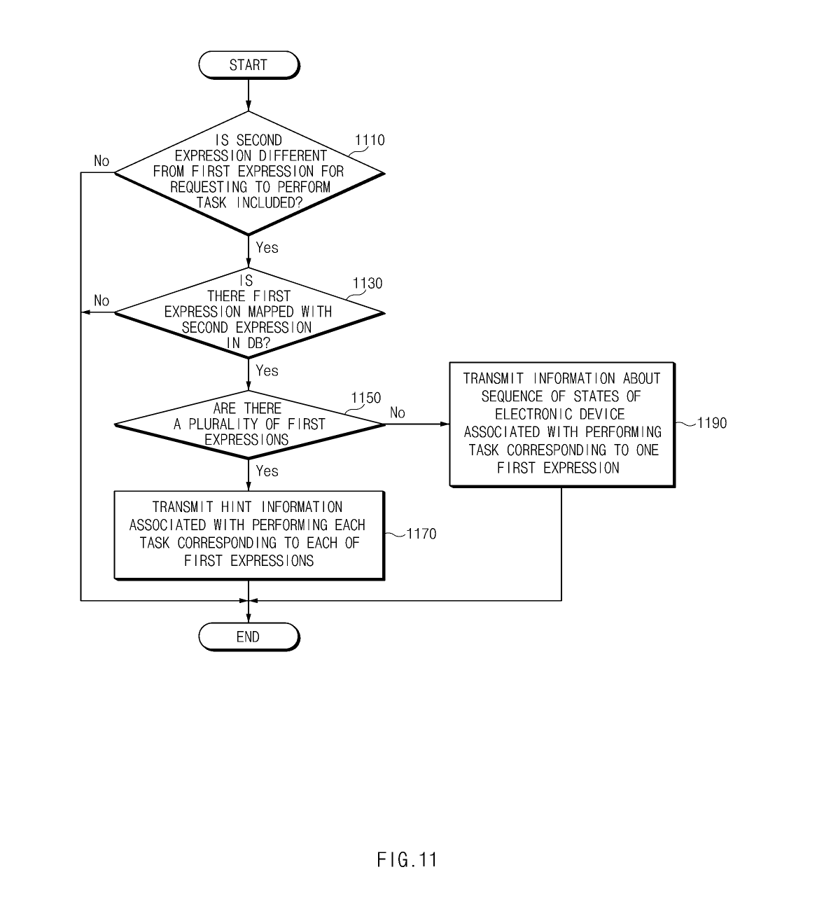

FIG. 11 is a flowchart illustrating an operation method of a system associated with processing an inexplicit expression mapped with a plurality of explicit expressions according to an embodiment of the present disclosure.

Referring to FIG. 11, when an utterance of a user is an inexplicit expression (or an indirect utterance) and when there are a plurality of explicit expressions (or a plurality of direct expressions) mapped with the inexplicit expression (or the direct expression) in a DB (e.g., an indirect utterance DB 225 of FIG. 6), a system (e.g., an intelligence server 200 of FIG. 6) may transmit hint information associated with the explicit expressions to an external device (e.g., a user terminal 100 of FIG. 6).

According to an embodiment, an ASR module 210 of the intelligence server 200 may obtain voice data corresponding to an utterance input of the user from the user terminal 100 and may convert the obtained voice data into text data. According to an embodiment, an utterance classification module 270 of the intelligence server 200 may classify at least one expression included in the text data. For example, the utterance classification module 270 may determine whether the at least one expression is an explicit expression for explicitly requesting to perform a task or an inexplicit expression to classify the at least one expression.

When the process of classifying the expression included in the text data is completed, in operation 1110, the system may determine whether a second expression (e.g., an inexplicit expression or an indirect explicit) except for the first expression (e.g., an explicit expression or a direct expression) requesting performance of a task is included in the text. For example, the utterance classification module 270 of the intelligence server 200 may verify whether the second expression is included in the text data.

When the second expression is detected in the text data, in operation 1130, the system may determine whether the first expression is mapped with the second expression in the DB. For example, the utterance classification module 270 may verify whether the inexplicit expression included in the text data is mapped with the explicit expression to be stored in the indirect utterance DB 225.

When the second expression is mapped to the first expression to be stored, in operation 1150, the system may verify the number of the first expressions mapped with the second expression. For example, the utterance classification module 270 may determine whether there are the plurality of explicit expressions mapped with the inexplicit expression in the indirect utterance DB 225.

Where there are a plurality of first expressions mapped with the second expression, in operation 1170, the system may transmit hint information associated with performing each task corresponding to each of the plurality of first expressions to the external device. For example, when there are the plurality of explicit expressions mapped with the inexplicit expression in the indirect utterance DB 225, the intelligence server 200 may transmit hint information associated with performing each task corresponding to each of the explicit expressions to the user terminal 100. Thus, the terminal 100 may provide the hint information to a user, and the user may select a task to be performed using the hint information.

In some embodiments, the system may transmit information about a sequence of states of an external device associated with performing each task corresponding to each of the explicit expressions to the external device, rather than transmitting the hint information to the external device. For example, the intelligence server 200 may transmit path rules respectively corresponding to the explicit expressions to the user terminal 100.

In contrast, when there is a single first expression mapped with the second expression, in operation 1190, the system may transmit information about a sequence of states of the external device associated with performing a task corresponding to the single first expression. For example, the intelligence server 200 may transmit a path rule corresponding to the one explicit expression to the user terminal 100.

According to an embodiment, when the system transmits the hint information to the external device, the external device may provide the hint information to the user and the user may select one task to be performed based on the hint information. In this case, the external device may feed the selected task information back to the system. Receiving the task information, the system may map and store the selected task information and the explicit express in the DB. For example, the system may accumulate the task information associated with the inexplicit expression in the DB. Thus, when the inexplicit expression is spoken, the system may vary a weight to select a task to be provided to the external device, with reference to task information stored in connection with the inexplicit expression. For example, the system may vary an order where hint information is displayed, depending on the weight.

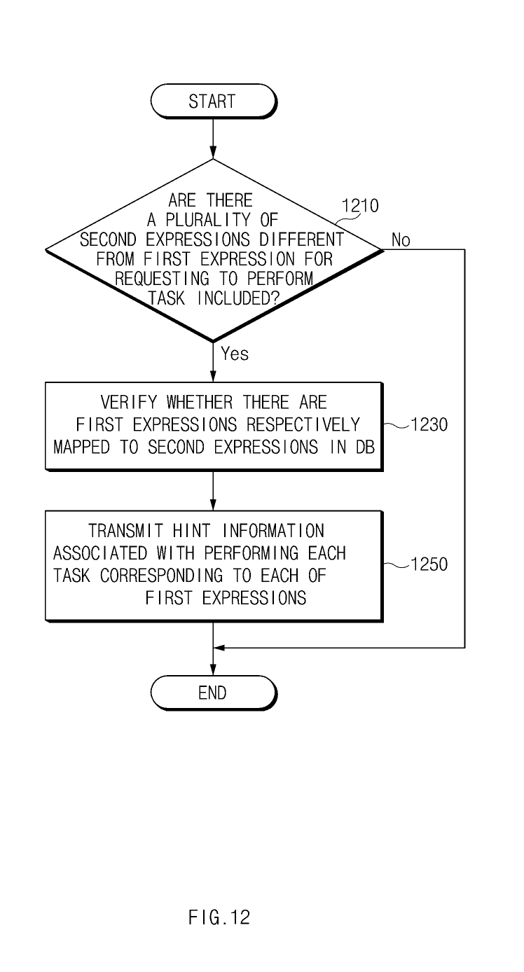

FIG. 12 is a flowchart illustrating an operation method of a system associated with processing a plurality of inexplicit expression according to an embodiment of the present disclosure.

Referring to FIG. 12, when an utterance of a user is an inexplicit expression (or an indirect utterance) and when a plurality of inexplicit expressions (or a plurality of indirect expressions) are included in the utterance of the user, a system (e.g., an intelligence server 200 of FIG. 6) may transmit hint information associated with performing each task corresponding to each of the plurality of inexplicit expressions to an external device (e.g., a user terminal 100 of FIG. 6).

According to an embodiment, an ASR module 210 of the intelligence server 200 may obtain voice data corresponding to an utterance input of the user from the user terminal 100 and may convert the obtained voice data into text data. According to an embodiment, an utterance classification module 270 of the intelligence server 200 may classify at least one expression included in the text data. For example, the utterance classification module 270 may determine whether the at least one expression is an explicit expression (or a direct expression) for explicitly requesting to perform a task or an inexplicit expression (or an indirect expression) to classify the at least one expression.

When the process of classifying the expression included in the text data is completed, in operation 1210, the system may determine whether a plurality of second expressions (e.g., a plurality of inexplicit expressions or a plurality of indirect expressions) different from a first expression (e.g., an explicit expression or a direct expression) for requesting performance of a task is included. For example, the utterance classification module 270 of the intelligence server 200 may verify whether the first expression is not included in the text data and whether the plurality of second expressions are included in the text data.

When the plurality of second expressions are included in the text data, in operation 1230, the system may verify whether there are the first expressions respectively mapped to the second expressions in a DB (e.g., an indirect utterance DB 225 of FIG. 6). For example, the utterance classification module 270 may verify whether each of the plurality of inexplicit expressions included in the text data is mapped with an explicit expression to be stored in the indirect utterance DB 225.

When the second expressions are respectively mapped to the different first expressions to be stored, in operation 1250, the system may transmit hint information associated with performing each task corresponding to each of the first expressions to the external device. For example, when the plurality of inexplicit expressions are included in the text data, the intelligence server 200 may verify the explicit expressions respectively mapped with the plurality of inexplicit expressions and may transmit the hint information associated with performing each task corresponding to each of the explicit expressions to the user terminal 100. Thus, the user terminal 100 may provide the hint information to the user, and the user may select a task to be performed using the hint information.

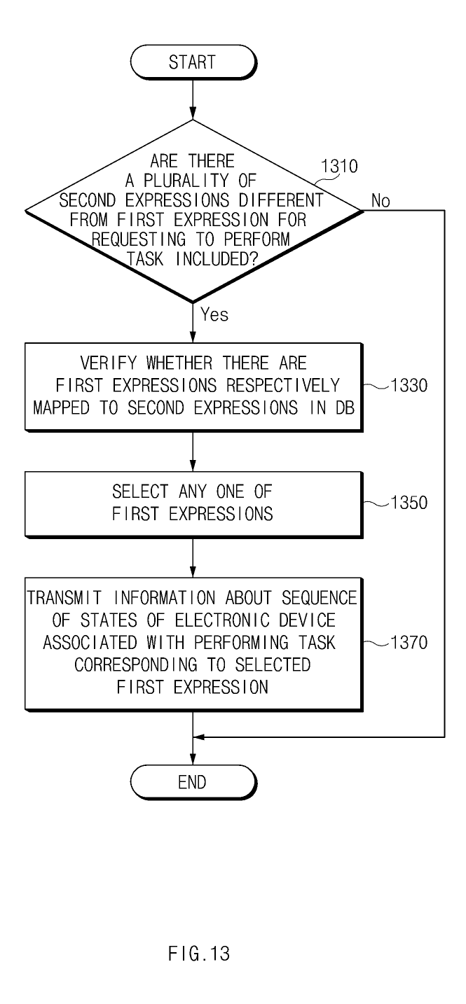

FIG. 13 is a flowchart illustrating another operation method of a system associated with processing a plurality of inexplicit expression according to an embodiment of the present disclosure.

Referring to FIG. 13, when an utterance of a user is an inexplicit expression (or an indirect utterance) and when a plurality of inexplicit expressions (or a plurality of indirect expressions) are included in the utterance of the user, a system (e.g., an intelligence server 200 of FIG. 6) may select a task corresponding to any one of the plurality of inexplicit expressions and may transmit information (e.g., a path rule) about a sequence of states of an external device (e.g., a user terminal 100 of FIG. 6) associated with performing the selected task to the external device.

According to an embodiment, an ASR module 210 of the intelligence server 200 may obtain voice data corresponding to an utterance input of the user from the user terminal 100 and may convert the obtained voice data into text data. According to an embodiment, an utterance classification module 270 of the intelligence server 200 may classify at least one expression included in the text data. For example, the utterance classification module 270 may determine whether the at least one expression is an explicit expression (or a direct expression) for explicitly requesting to perform a task or an inexplicit expression (or an indirect expression) to classify the at least one expression.

When the process of classifying the expression included in the text data is completed, in operation 1310, the system may determine whether a plurality of second expressions (e.g., a plurality of inexplicit expressions or a plurality of indirect expressions) except for a first expression (e.g., an explicit expression or a direct expression) for requesting to perform a task are included. For example, the utterance classification module 270 of the intelligence server 200 may verify whether the first expression is not included in the text data and whether the plurality of second expressions are included in the text data.

When the plurality of second expressions are included in the text data, in operation 1330, the system may verify whether there are the first expressions respectively mapped to the second expressions in a DB (e.g., an indirect utterance DB 225 of FIG. 6). For example, the utterance classification module 270 may verify whether each of the plurality of inexplicit expressions included in the text data is mapped with an explicit expression to be stored in the indirect utterance DB 225.

When the second expressions are respectively mapped to the different first expressions to be stored, in operation 1350, the system may select any one of the first expressions. For example, the intelligence server 200 may select any one of explicit expressions respectively mapped to the inexplicit expressions. For example, the intelligence server 200 may select any one of the explicit expressions based on priorities of inexplicit expressions respectively corresponding to the explicit expressions. The priorities may be determined by, for example, the number of inexplicit expressions respectively mapped to the explicit expressions, a frequency of use of the inexplicit expressions, user information, or the like.

When the any one of the first expressions is selected, in operation 1370, the system may transmit information about a sequence of states of the external device associated with performing a task corresponding to the selected first expression to the external device. For example, the intelligence server 200 may transmit a path rule corresponding to the selected explicit expression to the user terminal 100.

As described above, according to various embodiments, a voice data processing method of an electronic device may include obtaining voice data from an external device via a communication circuit of the electronic device, converting the voice data into text data, classifying at least one expression included in the text data, when the at least one expression includes a first expression for requesting to perform a first task using the external device, transmitting first information about a sequence of states of the external device associated with performing the first task to the external device via the communication circuit, and when the at least one expression does not include the first expression and includes a second expression different from the first expression and when there is the first expression mapped with the second expression in a DB, transmitting the first information to the external device via the communication circuit.

According to various embodiments, the first expression may include at least one of an identifier of an application executable by the external device and a command set to execute a function of the application.

According to various embodiments, the method may further include mapping at least one of the first expression and second information associated with the first task to the second expression and storing the mapping information, when the at least one expression includes the first expression and the second expression.

According to various embodiments, the method may further include transmitting first hint information associated with performing the first task corresponding to the first expression and at least one second hint information associated with performing at least one second task corresponding to at least one third expression to the external device, when the at least one expression does not include the first expression and includes the second expression different from the first expression and when there are the first expression mapped with the second expression and the at least one third expression different from the first expression in the DB.

According to various embodiments, the method may further include selecting any one of the first expression and at least one third expression based on priorities of the first expression and the at least one third expression and transmitting information about a sequence of states of the external device associated with performing a task corresponding to the selected expression to the external device, when the at least one expression does not include the first expression and includes the second expression different from the first expression and when there are the first expression mapped with the second expression and the at least one third expression different from the first expression in the DB.

According to various embodiments, the method may further include transmitting first hint information associated with performing the first task corresponding to the first expression and at least one second hint information associated with performing at least one second task corresponding to at least one fourth expression to the external device, when the at least one expression does not include the first expression and includes the second expression and at least one third expression, which are different from the first expression, and when there are the first expression mapped with the second expression and the at least one fourth expression mapped with the at least one third expression in the DB.

According to various embodiments, the method may further include selecting any one of the first expression and at least one fourth expression based on priorities of the first expression and the at least one fourth expression and transmitting information about a sequence of states of the external device associated with performing a task corresponding to the selected expression to the external device, when the at least one expression does not include the first expression and includes the second expression and at least one third expression, which are different from the first expression, and when there are the first expression mapped with the second expression and the at least one fourth expression mapped with the at least one third expression in the DB.

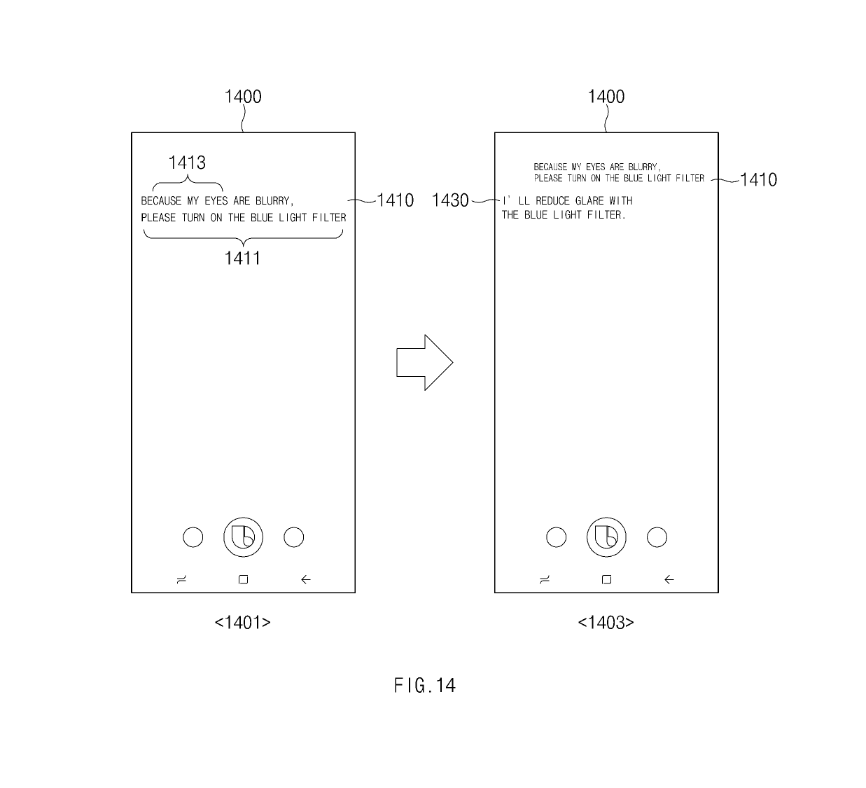

FIG. 14 is a drawing illustrating a screen associated with processing voice data according to an embodiment of the present disclosure.

Referring to FIG. 14, an electronic device (e.g., a user terminal 100 of FIG. 6) may receive an utterance input (i.e., voice input or voice command) of a user via a microphone (e.g., a microphone 111 of FIG. 3) and may transmit the detected voice data corresponding to the utterance to an external device (e.g., an intelligence server 200 of FIG. 6). In this case, the external device may convert the received voice data into text data and may transmit the converted text data back to the electronic device. Thus, in state 1401, the electronic device may output received text data 1410 on a display 1400, as seen in example 1401.

According to an embodiment, the external device may classify at least one expression included in the received text data 1410. For example, an utterance classification module 270 of the intelligence server 200 may determine whether the at least one expression included in the text data 1410 is an explicit expression (or a direct expression) for explicitly requesting to perform a task or an inexplicit expression (or an indirect expression) to classify the at least one expression.

According to an embodiment, the explicit expression may include an expression explicitly requesting performance of a task. For example, the explicit expression may include an essential element (e.g., a domain, intent, etc.) utilizable to perform the task. For example, the explicit expression may include an identifier of an executable application, a command configured to execute a function (or operation) of the application, or the like. In the shown drawing, when the user states “because my eyes are blurry, please turn on the blue light filter”, the sentence “please turn on the blue light filter” may be determined to be an utterance portion 1411 corresponding to a command to execute the blue light filter function, and may thus be considered an ‘explicit’ expression. The inexplicit expression in contrast may include an expression separate and distinct from the explicit expression nevertheless indicated in the text. For example, the inexplicit expression may include an additional element (e.g., such as a parameter) which can customize a task or otherwise be used when the task is performed, or an unnecessary element (e.g., an exclamation) which is irrelevant to performing the task. In the depicted example, the text “because my eyes are blurry” is an utterance portion 1413 which is irrelevant to performing the function of activating the blue light filter and may correspond to an example of an inexplicit expression.

According to an embodiment, when the process of classifying the expression (e.g., the explicit expression 1411 and the inexplicit expression 1413) included in the text data 1410 is completed, the external device may generate (or select) information about a sequence of states of the electronic device associated with performing a task (e.g., the function of turning on the blue light filter), that is, a path rule based on the explicit expression 1411 and may transmit the path rule to the electronic device.

Receiving the path rule, the electronic device may perform the task depending on the path rule. According to an embodiment, in second state 1403, the electronic device may output a screen confirming performance of the task on the display 1400. For example, the electronic device may output text data 1410 corresponding to the utterance input of the user and an object 1430 (e.g., “I'll reduce glare with the blue light filter”) for providing a notification that the task will be performed, on the display 1400.

According to an embodiment, when the explicit expression 1411 and the inexplicit expression 1413 are included in the text data 1410, the external device may map and store the explicit expression 1411 and the inexplicit expression 1413 in a DB (e.g., an indirect utterance DB 225 of FIG. 6). Thus, although the inexplicit expression 1413 is spoken, the external device may perform the task using mapping information stored in the DB.

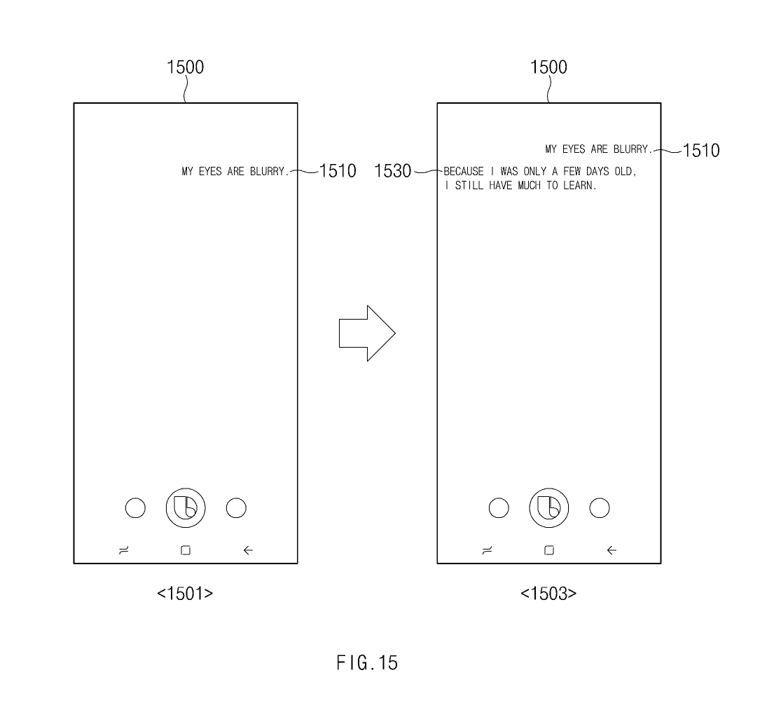

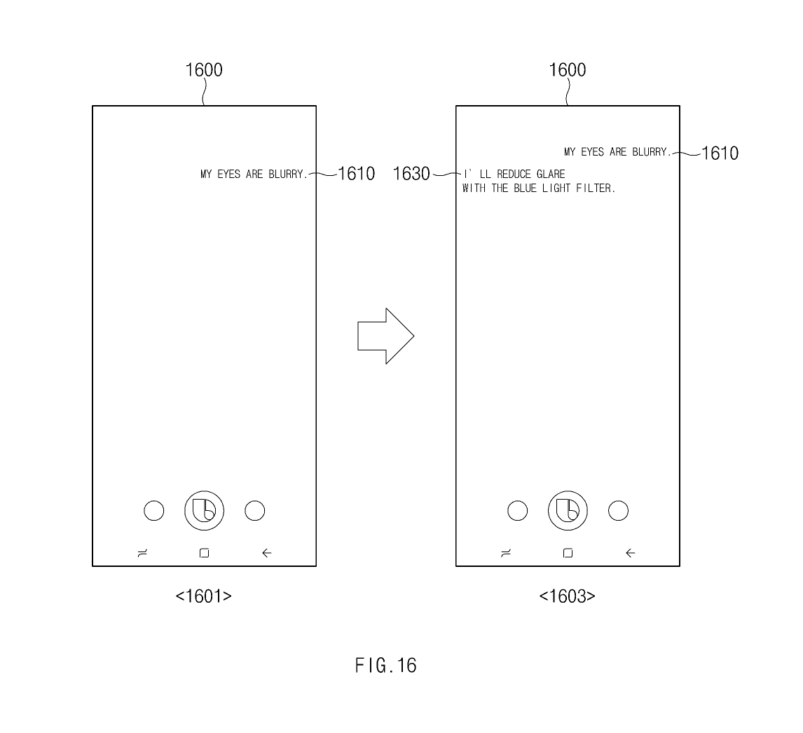

FIG. 15 is a drawing illustrating a case in which a task is fails to be performed upon receival of an inexplicit utterance, according to an embodiment of the present disclosure. FIG. 16 is a drawing illustrating a case in which a task is performed upon an inexplicit utterance, according to an embodiment of the present disclosure.

Referring to FIGS. 15 and 16, an electronic device (e.g., a user terminal 100 of FIG. 6) may receive an utterance input (i.e., a voice input or voice command) of a user via a microphone (e.g., a microphone 111 of FIG. 3) and may transmit voice data corresponding to the utterance input of the user to an external device (e.g., an intelligence server 200 of FIG. 6). In this case, the external device may convert the received voice data into text data and may transmit the converted text data to the electronic device. Thus, in first state 1501 or 1601, the electronic device may output received text data 1510 or 1610 on a display 1500 or 1600.

According to an embodiment, the external device may classify at least one expression included in each of the converted text data 1510 or 1560. For example, an utterance classification module 270 of the intelligence server 200 may determine whether the at least one expression included in the text data 1510 or 1610 is an explicit expression (or a direct expression) for explicitly requesting to perform a task, or an inexplicit expression (or an indirect expression) which may be used to classify the at least one expression. As shown in FIGS. 15 and 16, when the user speaks “my eyes are blurry”, the external device may analyze an utterance input and may determine that an explicit expression for explicitly requesting to perform a task is not included in the text data 1510 or 1610 corresponding to the utterance input of the user, and that an inexplicit expression 1510 or 1610 unassociated with performing the task is included in the text data 1510 or 1610.

According to an embodiment, the external device may verify whether there is an explicit expression mapped with the inexplicit expression 1510 or 1610 in a DB (e.g., an indirect utterance DB 225 of FIG. 6). For example, the utterance classification module 270 may verify whether there is an explicit expression (e.g., “Please turn on the blue light filter.”) mapped to the inexplicit expression 1510 or 1610, for example, “My eyes are blurry.”, in the indirect utterance DB 225. According to an embodiment, when storing mapping information in the DB, the external device may process expressions. For example, when mapping the sentences “my eyes are blurry” and “because my eyes are blurry” to the sentence “please turn on the blue light filter”, the external device may soundly store the sentences “my eyes are blurry” and “because my eyes are blurry”, but may process the sentences “my eyes are blurry” and “because my eyes are blurry” to be more broadly used. For example, the external device may extract the words “eyes” and “blurry” from the sentences and may map the words to manage the mapping information to refer to the mapping information when the sentence including the words is spoken. Alternatively, the external device may process and store an explicit expression associated with performing a task. In some embodiments, the external device may store information of a task corresponding to the explicit expression, rather than storing the explicit expression. For example, the external device may map the words “eyes” and “blurry” to information capable of identifying a function of turning on the blue light filter to store the mapping information in the DB.

According to an embodiment, when there is an explicit expression (or information of a task) mapped with the inexplicit expression 1510 or 1610 in the DB, the external device may generate (or select) information about a sequence of states of the electronic device associated with performing the task (e.g., the function of turning on the blue light filter), that is, a path rule and may transmit the path rule to the electronic device. In this case, receiving the path rule, the electronic device may perform the task depending on the path rule. According to an embodiment, in second state 1603 of FIG. 16, the electronic device may output a screen of providing a notification that the task will be performed on the display 1600. For example, the electronic device may output text data 1610 corresponding to an utterance input of the user and an object 1630 (e.g., “I'll reduce glare with the blue light filter.”) of providing a notification that the task will be performed, on the display 1600. Further, the electronic device may perform the task while outputting the object 1630 on the display 1600.

According to an embodiment, when there is no the explicit expression (or the information of the task) mapped with the inexplicit expression 1510 or 1610 in the DB, the external device may inform the electronic device that there is no the explicit expression (or the information of the task) mapped with the inexplicit expression 1510 or 1610. In this case, in second state 1503 of FIG. 15, the electronic device may output text data 1510 corresponding to an utterance input of the user and an object 1530 (e.g., “because I was only a few days old, I still have much to learn.”) of providing a notification that it is impossible to perform the task using the text data 1510 due to the fact that the inexplicit expression has yet to be mapped to an explicit expression definitively indicating a function to be executed.

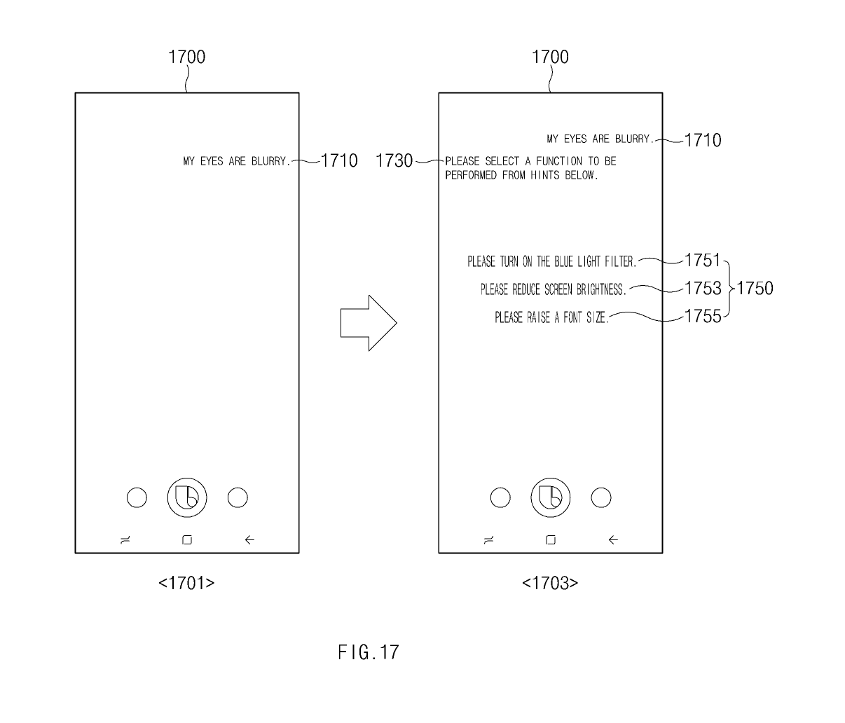

FIG. 17 is a drawing illustrating a method for processing an inexplicit expression mapped with a plurality of explicit expressions according to an embodiment of the present disclosure.

Referring to FIG. 17, an electronic device (e.g., a user terminal 100 of FIG. 6) may receive an utterance input of a user via a microphone (e.g., a microphone 111 of FIG. 3) and may transmit voice data corresponding to the utterance input of the user to an external device (e.g., an intelligence server 200 of FIG. 6). In this case, the external device may convert the received voice data into text data and may transmit the converted text data to the electronic device. Thus, in first state 1701, the electronic device may output received text data 1710 on a display 1700.

According to an embodiment, the external device may classify at least one expression included in the converted text data 1710. For example, an utterance classification module 270 of the intelligence server 200 may determine whether the at least one expression included in the text data 1710 is an explicit expression (or a direct expression) for explicitly requesting to perform a task or an inexplicit expression (or an indirect expression) to classify the at least one expression. As shown in FIG. 17, when the user speaks “my eyes are blurry”, the external device may determine that an explicit expression for explicitly requesting to perform a task is not included in the text data 1710 corresponding to an utterance input of the user and that the inexplicit expression 1710 unassociated with performing the task is included in the text data 1710.

According to an embodiment, the external device may verify whether there is an explicit expression mapped with the inexplicit expression 1710 in a DB (e.g., an indirect utterance DB 225 of FIG. 6). When there are a plurality of explicit expressions (or a plurality of information of a task) mapped with the inexplicit expression 1710 in the DB, the external device may transmit hint information associated with performing each task corresponding to each of the explicit expressions to the electronic device.

Receiving the hint information, in second state 1703, the electronic device may output the received hint information on the display 1700. For example, the electronic device may output the text data 1710 corresponding to an utterance input of the user, an object 1730 (e.g., “Please select a function to be performed from hints below.”) for requesting to select a task to be performed based on the hint information, and the hint information 1750 on the display 1700.

According to an embodiment, the external device may designate an order where hint information associated with each task corresponding to each of the explicit expressions is displayed, based on priorities of the explicit expressions. For example, the external device may set priorities of the explicit expressions based on the number of times that a specific explicit expression together with the inexplicit expression 1710 is spoken, the number of times that a task is selected and performed from the user when the inexplicit expression 1710 is spoken, or the like. As a priority of each of the explicit expressions is higher, an order where hint information associated with a task corresponding to the explicit expression is displayed may be faster. For example, a first explicit expression 1751 among the first explicit expression 1751 (e.g., “Please turn on the blue light filter.”), a second explicit expression 1753 (e.g., “Please reduce screen brightness.”), and a third explicit expression 1755 (e.g. “Please raise a font size.”), which are mapped to the inexplicit expression 1710 (e.g., “My eyes are blurry.”), may have the highest priority, and the third explicit expression 1755 may have the lowest priority. The electronic device may output the first explicit expression 1751, the second explicit expression 1753, and the third explicit expression 1755 in order of priority.

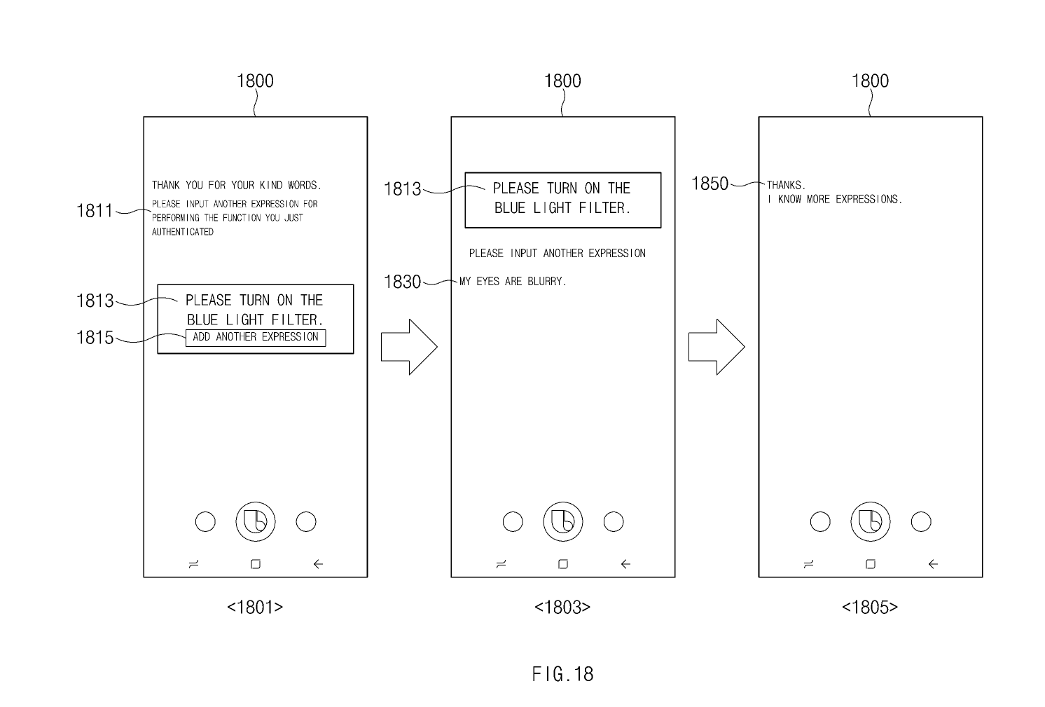

FIG. 18 is a drawing illustrating a screen associated with training an inexplicit utterance according to an embodiment of the present disclosure.

Referring to FIG. 18, an electronic device (e.g., a user terminal 100 of FIG. 6) may provide an interface to train an inexplicit utterance (or an indirect utterance). According to an embodiment, when there is an explicit expression 1813 (e.g., “Please turn on a blue light.”) for explicitly requesting to perform a task in an utterance input of a user, the electronic device may provide an interface to ‘train’ inexplicit expressions capable of being mapped to the explicit expression 1813, meaning that the electronic device can receive new inexplicit expressions and map them to explicit expressions so that in the future, inexplicit expressions may be used to execute corresponding functions even when explicit expressions are lacking.

According to an embodiment, in first state 1801, the electronic device may output an object 1811 for providing a notification that it is possible to train an inexplicit expression capable of being mapped to the explicit expression 1813, the explicit expression 1813, and an object 1815 (e.g., a button) set to input the inexplicit expression, on a display 1800.

According to an embodiment, when the object 1815 set to input the inexplicit expression is selected, the electronic device may receive an utterance input from the user via a microphone (e.g., a microphone 111 of FIG. 3). For example, an inexplicit expression 1830 (e.g., “My eyes are blurry.”) to be mapped to the explicit expression 1813, which may be included in the utterance input. When the inexplicit expression 1830 is input, in state 1803, the electronic device may output the received inexplicit expression 1830 together with the explicit expression 1813 on the display 1800. Further, the electronic device may transmit the received inexplicit expression 1830 to an external device (e.g., an intelligence server 200 of FIG. 6). The external device may map the received inexplicit expression 1830 to the explicit expression 1813 to store the mapping information in a DB (e.g., an indirect utterance DB 225 of FIG. 6).

According to an embodiment, in third state 1805, the electronic device may output an object 1850 (e.g., “Thank you for your kind words. I know more expressions.”) for providing a notification that the inexplicit expression 1830 has successfully been mapped to the explicit expression 1813, on the display 1800.

According to an embodiment, after third state 1805, when a specified time elapses or when an input (e.g., a touch input) of the user occurs, the electronic device may return to first state 1801 or second state 1803 and may provide an interface to further train another inexplicit expression.

In some embodiments, the intelligence server 200 may update or share the indirect utterance DB 225 for the user with an indirect utterance DB for another user. For example, the intelligence server 200 may enhance an ability to perform a task for an inexplicit utterance using the indirect utterance DB of the other user.

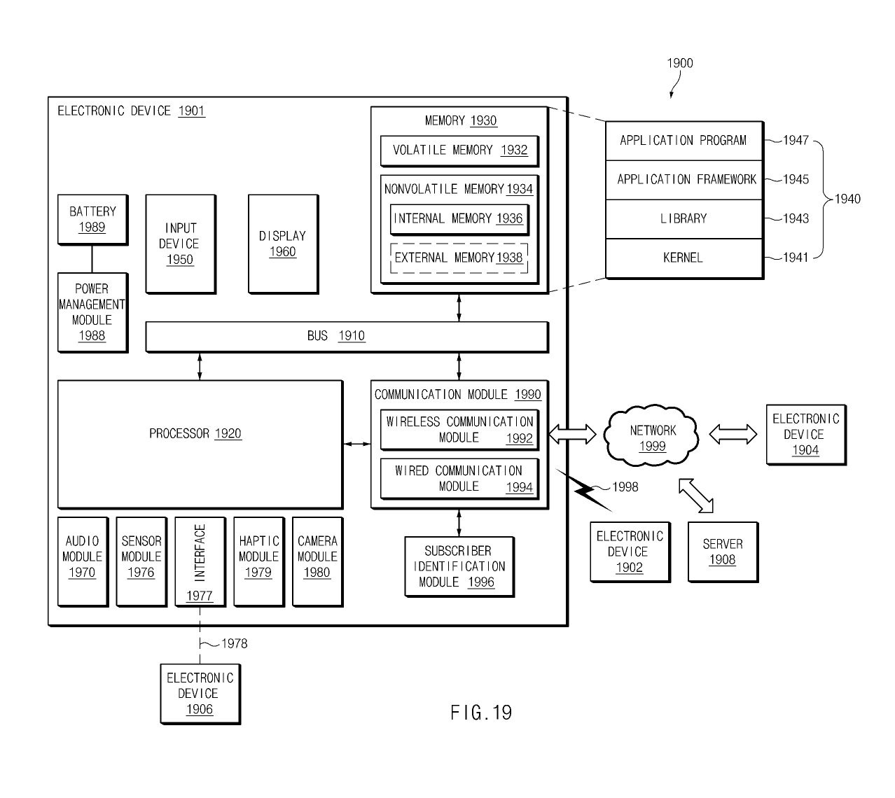

FIG. 19 illustrates a block diagram of an electronic device 1901 in a network environment 1900, according to various embodiments. An electronic device according to various embodiments of this disclosure may include various forms of devices. For example, the electronic device may include at least one of, for example, portable communication devices (e.g., smartphones), computer devices (e.g., personal digital assistants (PDAs), tablet personal computers (PCs), laptop PCs, desktop PCs, workstations, or servers), portable multimedia devices (e.g., electronic book readers or Motion Picture Experts Group (MPEG-1 or MPEG-2) Audio Layer 3 (MP3) players), portable medical devices (e.g., heartbeat measuring devices, blood glucose monitoring devices, blood pressure measuring devices, and body temperature measuring devices), cameras, or wearable devices. The wearable device may include at least one of an accessory type (e.g., watches, rings, bracelets, anklets, necklaces, glasses, contact lens, or head-mounted-devices (HMDs)), a fabric or garment-integrated type (e.g., an electronic apparel), a body-attached type (e.g., a skin pad or tattoos), or a bio-implantable type (e.g., an implantable circuit). According to various embodiments, the electronic device may include at least one of, for example, televisions (TVs), digital versatile disk (DVD) players, audios, audio accessory devices (e.g., speakers, headphones, or headsets), refrigerators, air conditioners, cleaners, ovens, microwave ovens, washing machines, air cleaners, set-top boxes, home automation control panels, security control panels, game consoles, electronic dictionaries, electronic keys, camcorders, or electronic picture frames.

In another embodiment, the electronic device may include at least one of navigation devices, satellite navigation system (e.g., Global Navigation Satellite System (GNSS)), event data recorders (EDRs) (e.g., black box for a car, a ship, or a plane), vehicle infotainment devices (e.g., head-up display for vehicle), industrial or home robots, drones, automatic teller's machines (ATMs), points of sales (POSs), measuring instruments (e.g., water meters, electricity meters, or gas meters), or internet of things (e.g., light bulbs, sprinkler devices, fire alarms, thermostats, or street lamps). The electronic device according to an embodiment of this disclosure may not be limited to the above-described devices, and may provide functions of a plurality of devices like smartphones which has measurement function of personal biometric information (e.g., heart rate or blood glucose). In this disclosure, the term “user” may refer to a person who uses an electronic device or may refer to a device (e.g., an artificial intelligence electronic device) that uses the electronic device.

Referring to FIG. 19, under the network environment 1900, the electronic device 1901 (e.g., the user terminal 100) may communicate with an electronic device 1902 through local wireless communication 1998 or may communication with an electronic device 1904 or a server 1908 (e.g., the intelligence server 200) through a network 1999. According to an embodiment, the electronic device 1901 may communicate with the electronic device 1904 through the server 1908.

According to an embodiment, the electronic device 1901 may include a bus 1910, a processor 1920 (e.g., the processor 150), a memory 1930 (e.g., the memory 140), an input device 1950 (e.g., the microphone 111 or a mouse), a display device 1960 (e.g., the display 120), an audio module 1970 (e.g., the speaker 130), a sensor module 1976, an interface 1977, a haptic module 1979, a camera module 1980, a power management module 1988, a battery 1989, a communication module 1990, and a subscriber identification module 1996. According to an embodiment, the electronic device 1901 may not include at least one (e.g., the display device 1960 or the camera module 1980) of the above-described elements or may further include other element(s).

The bus 1910 may interconnect the above-described elements 1920 to 1990 and may include a circuit for conveying signals (e.g., a control message or data) between the above-described elements.

The processor 1920 may include one or more of a central processing unit (CPU), an application processor (AP), a graphic processing unit (GPU), an image signal processor (ISP) of a camera or a communication processor (CP). According to an embodiment, the processor 1920 may be implemented with a system on chip (SoC) or a system in package (SiP). For example, the processor 1920 may drive an operating system (OS) or an application to control at least one of another element (e.g., hardware or software element) connected to the processor 1920 and may process and compute various data. The processor 1920 may load a command or data, which is received from at least one of other elements (e.g., the communication module 1990), into a volatile memory 1932 to process the command or data and may store the result data into a nonvolatile memory 1934.

The memory 1930 may include, for example, the volatile memory 1932 or the nonvolatile memory 1934. The volatile memory 1932 may include, for example, a random access memory (RAM) (e.g., a dynamic RAM (DRAM), a static RAM (SRAM), or a synchronous DRAM (SDRAM)). The nonvolatile memory 1934 may include, for example, a programmable read-only memory (PROM), an one time PROM (OTPROM), an erasable PROM (EPROM), an electrically EPROM (EEPROM), a mask ROM, a flash ROM, a flash memory, a hard disk drive (HDD), or a solid-state drive (SSD). In addition, the nonvolatile memory 1934 may be configured in the form of an internal memory 1936 or the form of an external memory 1938 which is available through connection if desired, according to the connection with the electronic device 1901. The external memory 1938 may further include a flash drive such as compact flash (CF), secure digital (SD), micro secure digital (Micro-SD), mini secure digital (Mini-SD), extreme digital (xD), a multimedia card (MMC), or a memory stick. The external memory 1938 may be operatively or physically connected with the electronic device 1901 in a wired manner (e.g., a cable or a universal serial bus (USB)) or a wireless (e.g., Bluetooth) manner.

For example, the memory 1930 may store, for example, at least one different software element, such as an instruction or data associated with the program 1940, of the electronic device 1901. The program 1940 may include, for example, a kernel 1941, a library 1943, an application framework 1945 or an application program (interchangeably, “application”) 1947.

The input device 1950 may include a microphone, a mouse, or a keyboard. According to an embodiment, the keyboard may include a keyboard physically connected or a virtual keyboard displayed through the display 1960.

The display 1960 may include a display, a hologram device or a projector, and a control circuit to control a relevant device. The screen may include, for example, a liquid crystal display (LCD), a light emitting diode (LED) display, an organic LED (OLED) display, a microelectromechanical systems (MEMS) display, or an electronic paper display. According to an embodiment, the display may be flexibly, transparently, or wearably implemented. The display may include a touch circuitry, which is able to detect a user's input such as a gesture input, a proximity input, or a hovering input or a pressure sensor (interchangeably, a force sensor) which is able to measure the intensity of the pressure by the touch. The touch circuit or the pressure sensor may be implemented integrally with the display or may be implemented with at least one sensor separately from the display. The hologram device may show a stereoscopic image in a space using interference of light. The projector may project light onto a screen to display an image. The screen may be located inside or outside the electronic device 1901.

The audio module 1970 may convert, for example, from a sound into an electrical signal or from an electrical signal into the sound. According to an embodiment, the audio module 1970 may acquire sound through the input device 1950 (e.g., a microphone) or may output sound through an output device (not illustrated) (e.g., a speaker or a receiver) included in the electronic device 1901, an external electronic device (e.g., the electronic device 1902 (e.g., a wireless speaker or a wireless headphone)) or an electronic device 1906 (e.g., a wired speaker or a wired headphone) connected with the electronic device 1901.

The sensor module 1976 may measure or detect, for example, an internal operating state (e.g., power or temperature) of the electronic device 1901 or an external environment state (e.g., an altitude, a humidity, or brightness) to generate an electrical signal or a data value corresponding to the information of the measured state or the detected state. The sensor module 1976 may include, for example, at least one of a gesture sensor, a gyro sensor, a barometric pressure sensor, a magnetic sensor, an acceleration sensor, a grip sensor, a proximity sensor, a color sensor (e.g., a red, green, blue (RGB) sensor), an infrared sensor, a biometric sensor (e.g., an iris sensor, a fingerprint sensor, a heartbeat rate monitoring (HRM) sensor, an e-nose sensor, an electromyography (EMG) sensor, an electroencephalogram (EEG) sensor, an electrocardiogram (ECG) sensor), a temperature sensor, a humidity sensor, an illuminance sensor, or an UV sensor. The sensor module 1976 may further include a control circuit for controlling at least one or more sensors included therein. According to an embodiment, the sensor module 1976 may be controlled by using the processor 1920 or a processor (e.g., a sensor hub) separate from the processor 1920. In the case that the separate processor (e.g., a sensor hub) is used, while the processor 1920 is in a sleep state, the separate processor may operate without awakening the processor 1920 to control at least a portion of the operation or the state of the sensor module 1976.

According to an embodiment, the interface 1977 may include a high definition multimedia interface (HDMI), a universal serial bus (USB), an optical interface, a recommended standard 232 (RS-232), a D-subminiature (D-sub), a mobile high-definition link (MHL) interface, a SD card/MMC (multi-media card) interface, or an audio interface. A connector 1978 may physically connect the electronic device 1901 and the electronic device 1906. According to an embodiment, the connector 1978 may include, for example, an USB connector, an SD card/MMC connector, or an audio connector (e.g., a headphone connector).

The haptic module 1979 may convert an electrical signal into mechanical stimulation (e.g., vibration or motion) or into electrical stimulation. For example, the haptic module 1979 may apply tactile or kinesthetic stimulation to a user. The haptic module 1979 may include, for example, a motor, a piezoelectric element, or an electric stimulator.

The camera module 1980 may capture, for example, a still image and a moving picture. According to an embodiment, the camera module 1980 may include at least one lens (e.g., a wide-angle lens and a telephoto lens, or a front lens and a rear lens), an image sensor, an image signal processor, or a flash (e.g., a light emitting diode or a xenon lamp).

The power management module 1988, which is to manage the power of the electronic device 1901, may constitute at least a portion of a power management integrated circuit (PMIC).

The battery 1989 may include a primary cell, a secondary cell, or a fuel cell and may be recharged by an external power source to supply power at least one element of the electronic device 1901.

The communication module 1990 may establish a communication channel between the electronic device 1901 and an external device (e.g., the first external electronic device 1902, the second external electronic device 1904, or the server 1908). The communication module 1990 may support wired communication or wireless communication through the established communication channel. According to an embodiment, the communication module 1990 may include a wireless communication module 1992 or a wired communication module 1994. The communication module 1990 may communicate with the external device through a first network 1998 (e.g. a wireless local area network such as Bluetooth or infrared data association (IrDA)) or a second network 1999 (e.g., a wireless wide area network such as a cellular network) through a relevant module among the wireless communication module 1992 or the wired communication module 1994.

The wireless communication module 1992 may support, for example, cellular communication, local wireless communication, global navigation satellite system (GNSS) communication. The cellular communication may include, for example, long-term evolution (LTE), LTE Advance (LTE-A), code division multiple access (CMA), wideband CDMA (WCDMA), universal mobile telecommunications system (UMTS), wireless broadband (WiBro), or global system for mobile communications (GSM). The local wireless communication may include wireless fidelity (Wi-Fi), WiFi Direct, light fidelity (Li-Fi), Bluetooth, Bluetooth low energy (BLE), Zigbee, near field communication (NFC), magnetic secure transmission (MST), radio frequency (RF), or a body area network (BAN). The GNSS may include at least one of a global positioning system (GPS), a global navigation satellite system (Glonass), Beidou Navigation Satellite System (Beidou), the European global satellite-based navigation system (Galileo), or the like. In the present disclosure, “GPS” and “GNSS” may be interchangeably used.

According to an embodiment, when the wireless communication module 1992 supports cellar communication, the wireless communication module 1992 may, for example, identify or authenticate the electronic device 1901 within a communication network using the subscriber identification module (e.g., a SIM card) 1996. According to an embodiment, the wireless communication module 1992 may include a communication processor (CP) separate from the processor 1920 (e.g., an application processor (AP)). In this case, the communication processor may perform at least a portion of functions associated with at least one of elements 1910 to 1996 of the electronic device 1901 in substitute for the processor 1920 when the processor 1920 is in an inactive (sleep) state, and together with the processor 1920 when the processor 1920 is in an active state. According to an embodiment, the wireless communication module 1992 may include a plurality of communication modules, each supporting a relevant communication scheme among cellular communication, local wireless communication, or a GNSS communication.

The wired communication module 1994 may include, for example, a local area network (LAN) service, a power line communication, or a plain old telephone service (POTS).

For example, the first network 1998 may employ, for example, Wi-Fi direct or Bluetooth for transmitting or receiving one or more instructions or data through wireless direct connection between the electronic device 1901 and the first external electronic device 1902. The second network 1999 may include a telecommunication network (e.g., a computer network such as a LAN or a WAN, the Internet or a telephone network) for transmitting or receiving one or more instructions or data between the electronic device 1901 and the second electronic device 1904.

According to various embodiments, the one or more instructions or the data may be transmitted or received between the electronic device 1901 and the second external electronic device 1904 through the server 1908 connected with the second network 1999. Each of the first and second external electronic devices 1902 and 1904 may be a device of which the type is different from or the same as that of the electronic device 1901. According to various embodiments, all or a part of operations that the electronic device 1901 will perform may be executed by another or a plurality of electronic devices (e.g., the electronic devices 1902 and 1904 or the server 1908). According to an embodiment, in the case that the electronic device 1901 executes any function or service automatically or in response to a request, the electronic device 1901 may not perform the function or the service internally, but may alternatively or additionally transmit requests for at least a part of a function associated with the electronic device 1901 to any other device (e.g., the electronic device 1902 or 1904 or the server 1908). The other electronic device (e.g., the electronic device 1902 or 1904 or the server 1908) may execute the requested function or additional function and may transmit the execution result to the electronic device 1901. The electronic device 1901 may provide the requested function or service using the received result or may additionally process the received result to provide the requested function or service. To this end, for example, cloud computing, distributed computing, or client-server computing may be used.

Various embodiments of the present disclosure and terms used herein are not intended to limit the technologies described in the present disclosure to specific embodiments, and it should be understood that the embodiments and the terms include modification, equivalent, and/or alternative on the corresponding embodiments described herein. With regard to description of drawings, similar elements may be marked by similar reference numerals. The terms of a singular form may include plural forms unless otherwise specified. In the disclosure disclosed herein, the expressions “A or B”, “at least one of A and/or B”, “at least one of A and/or B”, “A, B, or C”, or “at least one of A, B, and/or C”, and the like used herein may include any and all combinations of one or more of the associated listed items. Expressions such as “first,” or “second,” and the like, may express their elements regardless of their priority or importance and may be used to distinguish one element from another element but is not limited to these components. When an (e.g., first) element is referred to as being “(operatively or communicatively) coupled with/to” or “connected to” another (e.g., second) element, it may be directly coupled with/to or connected to the other element or an intervening element (e.g., a third element) may be present.

According to the situation, the expression “adapted to or configured to” used herein may be interchangeably used as, for example, the expression “suitable for”, “having the capacity to”, “changed to”, “made to”, “capable of” or “designed to” in hardware or software. The expression “a device configured to” may mean that the device is “capable of” operating together with another device or other components. For example, a “processor configured to (or set to) perform A, B, and C” may mean a dedicated processor (e.g., an embedded processor) for performing corresponding operations or a generic-purpose processor (e.g., a central processing unit (CPU) or an application processor) which performs corresponding operations by executing one or more software programs which are stored in a memory device (e.g., the memory 1930).

The term “module” used herein may include a unit, which is implemented with hardware, software, or firmware, and may be interchangeably used with the terms “logic”, “logical block”, “component”, “circuit”, or the like. The “module” may be a minimum unit of an integrated component or a part thereof or may be a minimum unit for performing one or more functions or a part thereof. The “module” may be implemented mechanically or electronically and may include, for example, an application-specific IC (ASIC) chip, a field-programmable gate array (FPGA), and a programmable-logic device for performing some operations, which are known or will be developed.

According to various embodiments, at least a part of an apparatus (e.g., modules or functions thereof) or a method (e.g., operations) may be, for example, implemented by instructions stored in a computer-readable storage media (e.g., the memory 1930) in the form of a program module. The instruction, when executed by a processor (e.g., a processor 1920), may cause the processor to perform a function corresponding to the instruction. The computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), an embedded memory, and the like. The one or more instructions may contain a code made by a compiler or a code executable by an interpreter.

Each element (e.g., a module or a program module) according to various embodiments may be implemented as a single entity or a plurality of entities, a part of the above-described sub-elements may be omitted or may further include other sub-elements. Alternatively or additionally, after being integrated in one entity, some elements (e.g., a module or a program module) may identically or similarly perform the function executed by each corresponding element before integration. According to various embodiments, operations executed by modules, program modules, or other elements may be executed by a successive method, a parallel method, a repeated method, or a heuristic method, or at least one part of operations may be executed in different sequences or omitted. Alternatively, other operations may be added.

While the present disclosure has been shown and described with reference to various embodiments thereof, it will be understood by those skilled in the art that various changes in form and details may be made therein without departing from the present disclosure as defined by the appended claims and their equivalents.

What is claimed is:

1. An electronic device, comprising:
a network interface;
at least one processor operatively connected with the network interface; and
at least one memory operatively connected with the at least one processor,
wherein the at least one memory stores instructions executable to cause the at least one processor to:
in a first operation:
receive by the network interface first data associated with a first user input from a first external device including a microphone, the first user input including an explicit request for performing a task using at least one of the first external device or a second external device;
identify a function requested by the first user input using natural understanding processing;
determine a sequence of states executable by the first external device or the second external device for executing the requested function; and
transmit first information indicating the determined sequence of the states to at least one of the first external device and the second external device using the network interface,
in second operation:
receive by the network interface second data associated with a second user input from the first external device, the second user input including a natural language expression;
identifying the function from the natural language expression, based at least in part on mappings of functions with natural language expressions previously received by the electronic device;
determine the sequence of the states executable by the first external device or the second external device for executing the identified function; and
transmit second information indicating the sequence of the states to at least one of the first external device and the second external device using the network interface.

2. The electronic device of claim 1, wherein the natural language expressions previously provided to the electronic device are stored in a database (DB).

3. The electronic device of claim 2, wherein the instructions cause the at least one processor to:
in a third operation:
receive by the network interface third data associated with a third user input from the first external device, the third user input including a second natural language expression;
detect whether there is a match between a previously stored sequence of states of the first external device or the second external device and the second natural language expression; and
when the match is detected, store the second natural language expression in the DB mapped to the previously stored sequence of states.

4. The electronic device of claim 3, wherein the instructions cause the at least one processor to:
in the third operation,
determine a score indicating whether there is the match between the second natural language expression and the previously stored sequence of states; and
when the score is not greater than a selected threshold, store the second natural language expression in the DB.

5. An electronic device, comprising:
a communication circuit;
at least one processor operatively connected with the communication circuit; and
at least one memory operatively connected with the at least one processor,
wherein the at least one memory stores instructions executable by the at least one processor to:
obtain voice data from an external device via the communication circuit;
convert the voice data into text data;
detect at least one expression included in the text data;
when the at least one expression includes a first expression mapped to a first task, transmit first information indicating a sequence of states associated with performing the first task to the external device via the communication circuit; and
when the at least one expression does not include the first expression and includes a second expression different from the first expression, and the second expression is mapped to the first expression as stored in a database (DB), transmit the first information to the external device via the communication circuit.

6. The electronic device of claim 5, wherein the first expression comprises:
at least one of an identifier indicating an application executable by the external device, and a command configured to execute a function of the application.

7. The electronic device of claim 5, wherein the
instructions are further executable by the processor to:
when the at least one expression includes the first expression and the second expression and the second expression is not yet mapped to the first expression, map the second expression to at least one of the first expression, and map second information associated with the first task to the first expression.

8. The electronic device of claim 5, wherein the instructions are further executable by the processor to:
when the at least one expression includes the second expression but not the first expression, and when the first expression is mapped to the second expression and at least one third expression different from the first expression in the DB, transmit to the external device first hint information associated with performing the first task corresponding to the first expression, and at least one second hint information associated with performing at least one second task corresponding to the at least one third expression.

9. The electronic device of claim 8, wherein the instructions are further executable by the processor to:
set an order in which the first hint information and the at least one second hint information are to be displayed, based on priorities pre-associated with the first expression and the at least one third expression.

10. The electronic device of claim 5, wherein the instructions are further executable by the processor to:
when the at least one expression does not include the first expression and includes the second expression different from the first expression, and when the first expression is mapped in the DB with the second expression and at least one third expression which is different from the first expression, select one of the first expression and the at least one third expression based on pre-associated priorities of the first expression and the at least one third expression, and
transmit information indicating a sequence of states of the external device associated with performing a particular task corresponding to the selected one of the first expression and the at least one third expression to the external device.

11. The electronic device of claim 5, wherein the instructions are further executable by the processor to:
when the at least one expression includes the second expression and at least one third expression but not the first expression, and when the first expression is mapped to the second expression and at least one fourth expression, and the at least one fourth expression is mapped to the at least one third expression in the DB, transmit first hint information associated with performing the first task corresponding to the first expression and at least one second hint information associated with performing at least one second task corresponding to the at least one fourth expression to the external device.

12. The electronic device of claim 11, wherein the instructions are further executable by the processor to:
designate an order in which the first hint information and the at least one second hint information are to be displayed, the order based on pre-associated priorities of the first expression and the at least one fourth expression.

13. The electronic device of claim 5, wherein the instructions are further executable by the processor to:
when the at least one expression includes the second expression and at least one third expression but not the first expression, and when the first expression is mapped to the second expression and at least one fourth expression is to with the at least one third expression in the DB, select one of the first expression and the at least one fourth expression based on priorities pre-associated with the first expression and the at least one fourth expression, and
transmit information indicating a sequence of states associated with performing a task corresponding to the selected expression to the external device.

14. A voice data processing method of an electronic device, the method comprising:
obtaining voice data from an external device via a communication circuit of the electronic device;
converting by a processor the voice data into text data;
detecting by the processor at least one expression included in the text data;
when the at least one expression includes a first expression, transmitting first information indicating a sequence of states associated with performing the first task to the external device via the communication circuit; and
when the at least one expression does not include the first expression and includes a second expression different from the first expression and the second expression is mapped to the first expression as stored in a database (DB), transmitting the first information to the external device via the communication circuit.

15. The method of claim 14, wherein the first expression comprises:
at least one of an identifier of indicating application executable by the external device and a command configured to execute a function of the application.

16. The method of claim 14, further comprising:
when the at least one expression includes the first expression and the second expression and the second expression is not yet mapped to the first expression, map the second expression to at least one of the first expression, and second information associated with the first task mapped to the first expression.

17. The method of claim 14, further comprising:
when the at least one expression includes the second expression but not the first expression, and when the first expression is mapped to the second expression and at least one third expression different from the first expression in the DB, transmitting to the external device first hint information associated with performing the first task corresponding to the first expression and at least one second hint information associated with performing at least one second task corresponding to the at least one third expression.

18. The method of claim 14, further comprising:
when the at least one expression includes the second expression but not the first expression, and when the first expression is mapped to the second expression and at least one third expression different from the first expression in the DB, selecting one of the first expression and the at least one third expression based on priorities pre-associated with the first expression and the at least one third expression, and
transmitting to the external device information indicating a sequence of states of the external device associated with performing a task corresponding to the selected expression.

19. The method of claim 14, further comprising:
when the at least one expression includes the second expression and at least one third expression but not the first expression, and when the first expression is mapped to the second expression and at least one fourth expression is mapped to the at least one third expression in the DB, transmitting to the external device first hint information associated with performing the first task corresponding to the first expression, and at least one second hint information associated with performing at least one second task corresponding to at the least one fourth expression.

20. The method of claim 14, further comprising:
when the at least one expression includes the second expression and at least one third expression but not the first expression, and when the first expression is mapped to the second expression and at least one fourth expression is mapped to the at least one third expression in the DB, selecting one of the first expression and the at least one fourth expression based on priorities pre-associated with the first expression and the at least one fourth expression, and
transmitting information to the external device indicating a sequence of states of the external device associated with performing a task corresponding to the selected expression.
